(19) United States
(12) Patent Application Publication
(10) Pub. No.: US 2015/0054766 A1
(43) Pub. Date: Feb. 26, 2015

(54) INFORMATION PROCESSING APPARATUS AND CONTROL METHOD

(71) Applicant: FUJITSU LIMITED, Kawasaki-shi (JP)

(72) Inventor: Makoto Ishida, Setagaya (JP)

(21) Appl. No.: 14/465,951

(22) Filed: Aug. 22, 2014

(30) Foreign Application Priority Data
Aug. 26, 2013 (JP) 2013-174801

(51) Int. Cl. G06F 3/041; G06F 3/0488

(52) U.S. Cl. CPC G06F 3/0416; G06F 3/04883; G06F 2203/04808; G06F 2203/04104
USPC 345/173

(57) ABSTRACT

An information processing apparatus includes a processor executing a process that causes the information processing apparatus to: perform first acquiring a type and an operation speed of a touch operation on an instruction field on a detection surface; perform second acquiring a load ratio of the apparatus; and perform setting an operating capability of the apparatus in accordance with the type of the touch operation and the load ratio of the apparatus.

### CROSS-REFERENCE TO RELATED APPLICATION

This application is based upon and claims the benefit of priority of the prior Japanese Patent Application No. 2013-174801, filed on Aug. 26, 2013, the entire contents of which are incorporated herein by reference.

### FIELD

The embodiments discussed herein are related to an information processing apparatus and a control method.

### BACKGROUND

With an advancement of an information & communication technology (ICT: Information and Communication Technology) over the recent years, a portable information processing apparatus such as a smart phone, a tablet PC (PC: Personal Computer) and a PDA (Personal Data Assistance) is configured to have much higher functions as a tendency. A user of the information processing apparatus (hereinafter simply referred to as the user) establishes a connection with the Internet (Internet) etc via, e.g., the information processing apparatus and enjoys a variety of ICT services provided on the Internet. The user starts up and executes applications (Application software, which will hereinafter be simply referred to as the application) preinstalled into the information processing apparatus, thereby utilizing the variety of ICT services linked to the applications. For example, the user executes the applications and is thereby enabled to transmit and receive mails, to browse contents such as moving pictures posted to an SNS (Social Networking Service) etc., to browse distribution information like disaster information etc., to participate in online games and to download the contents.

Further, as the information processing apparatus is configured to have the much higher functions, a processor (CPU: Central Processing Unit) mounted in the information processing apparatus is designed to have much higher performance as a tendency in order to process multiple contents provided. Then, the information processing apparatus designed for a higher-function/higher-performance scheme has a tendency of receiving increased power consumption because of a tendency that the power consumption rises.

A technology called, e.g., DVFS (Dynamic Voltage Frequency Scaling) is proposed against the increased power consumption of the information processing apparatus. The DVFS performs setting to, for instance, when a load on the processor is small, reduce a drive voltage of the processor and decrease a clock frequency of the processor etc., thereby restraining the power consumption of the processor.

It is to be noted that the following Patent documents exist as documents of the related arts, which contain descriptions of the technologies related to the present technology that will be described in the present specification.

### DOCUMENT OF RELATED ART

### Patent Document

[Patent document 1] Japanese Laid-Open Patent Publication No. 08-328685
[Patent document 2] Japanese Laid-Open Patent Publication No. 2010-39791

### SUMMARY

The information processing apparatus includes a processor executing a process that causes the information processing apparatus to: perform first acquiring a type and an operation speed of a touch operation on an instruction field on a detection surface; perform second acquiring a load ratio of the apparatus; and perform setting an operating capability of the apparatus in accordance with the type of the touch operation and the load ratio of the apparatus.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1A is a diagram of explaining a relationship between a CPU operating ratio and an operation frequency for emphasizing a restraint of power consumption;

FIG. 1B is a diagram of explaining the relationship between the CPU operating ratio and the operation frequency for emphasizing the restraint of the power consumption;

FIG. 1C is a diagram of explaining the relationship between the CPU operating ratio and the operation frequency for emphasizing the restraint of the power consumption;

FIG. 2A is a diagram of explaining the relationship between the CPU operating ratio and the operation frequency for putting an emphasis on ensuring performance;

FIG. 2B is a diagram of explaining the relationship between the CPU operating ratio and the operation frequency for putting the emphasis on ensuring the performance;

FIG. 2C is a diagram of explaining the relationship between the CPU operating ratio and the operation frequency for putting the emphasis on ensuring the performance;

FIG. 3 is a diagram of explaining a flick operation on an information processing apparatus;

FIG. 4 is a diagram of explaining a tap operation on the information processing apparatus;

FIG. 5A is a diagram of explaining an operation tendency of an operation finger related to the flick operation;

FIG. 5B is a diagram of explaining the operation tendency of the operation finger related to the tap operation;

FIG. 5C is a diagram of explaining the operation tendency of the operation finger related to a swipe operation;

FIG. 6 is a diagram illustrating an example of hardware architecture of the information processing apparatus in the embodiment;

FIG. 7 is a diagram of explaining a functional configuration of the information processing apparatus in the embodiment;

FIG. 8A1 is a diagram illustrating an example of a governor table related to the flick operation;

FIG. 8A2 is a diagram illustrating an example of a governor table related to the flick operation;

FIG. 8A3 is a diagram illustrating an example of a governor table related3 to the flick operation;

FIG. 8B1 is a diagram illustrating an example of the governor table related to the tap operation;

FIG. 8B2 is a diagram illustrating an example of the governor table related to the tap operation;

FIG. 8B3 is a diagram illustrating an example of the governor table related to the tap operation;

FIG. 8C1 is a diagram illustrating an example of the governor table related to the swipe operation;

FIG. 8C2 is a diagram illustrating an example of the governor table related to the swipe operation;

FIG. 8C3 is a diagram illustrating an example of the governor table related to the swipe operation; and

FIG. 9 is a flowchart illustrating a touch detecting process;

FIG. 10A is a flowchart illustrating a governor table switchover process;

FIG. 10B is a flowchart illustrating the governor table switchover process;

FIG. 11A is a diagram of explaining an applied example of the governor table related to the flick operation;

FIG. 11B is a diagram of explaining an applied example of the governor table related to the flick operation;

FIG. 12A is a diagram of explaining an applied example of the governor table related to the tap operation;

FIG. 12B is a diagram of explaining an applied example of the governor table related to the tap operation;

FIG. 13A is a diagram of explaining an applied example of the governor table related to the swipe operation; and

FIG. 13B is a diagram of explaining an applied example of the governor table related to the swipe operation.

### DESCRIPTION OF EMBODIMENTS

In the information processing apparatus having the DVFS function, for example, the clock frequency and the drive voltage of the processor are set to take an entire balance between the performance and the power consumption related to a processing load of the information processing apparatus.

For example, the information processing apparatus set in a power emphasized type sets to increase stepwise the drive voltage corresponding to a rise in processing load, operates at a much higher clock frequency and takes the entire balance between the performance and the power consumption related to the processing load. In the information processing apparatus set in the power emphasized type, however, the entire balance between the performance and the power consumption is set to restrain the power consumption in common between or among the variety of applications executed on the information processing apparatus. Therefore, for instance, in the application involving frequent use of a flick operation etc for scrolling a display area of the content containing image information, such a possibility exists that the performance of the information processing apparatus does not follow an operation instruction etc of the user.

On the other hand, e.g., the information processing apparatus set in a performance emphasized type increases the drive voltage steeply corresponding to the rise in processing load, sets to perform an operation at a high clock frequency, and takes the entire balance between the performance and the power consumption related to the processing load. In the information processing apparatus set in the performance emphasized type, however, the entire balance between the performance and the power consumption is set to ensure the performance in common between or among the variety of applications executed on the information processing apparatus. Hence, for instance, in the application waiting for an operation input of a tap operation or the like of the user about the displayed content, the excessive performance for the processing load is set as the case may be, and hence there exists a tendency of reducing an effect in restraining the power consumption.

An information processing apparatus according to one embodiment will hereinafter be described with reference to the drawings. A configuration of the following embodiment is an exemplification, and the information processing apparatus is not limited to the configuration of the embodiment.

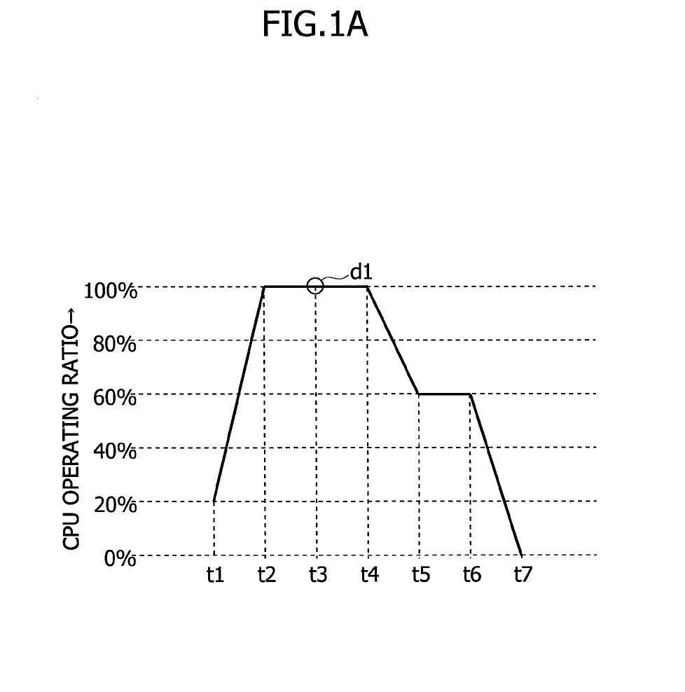

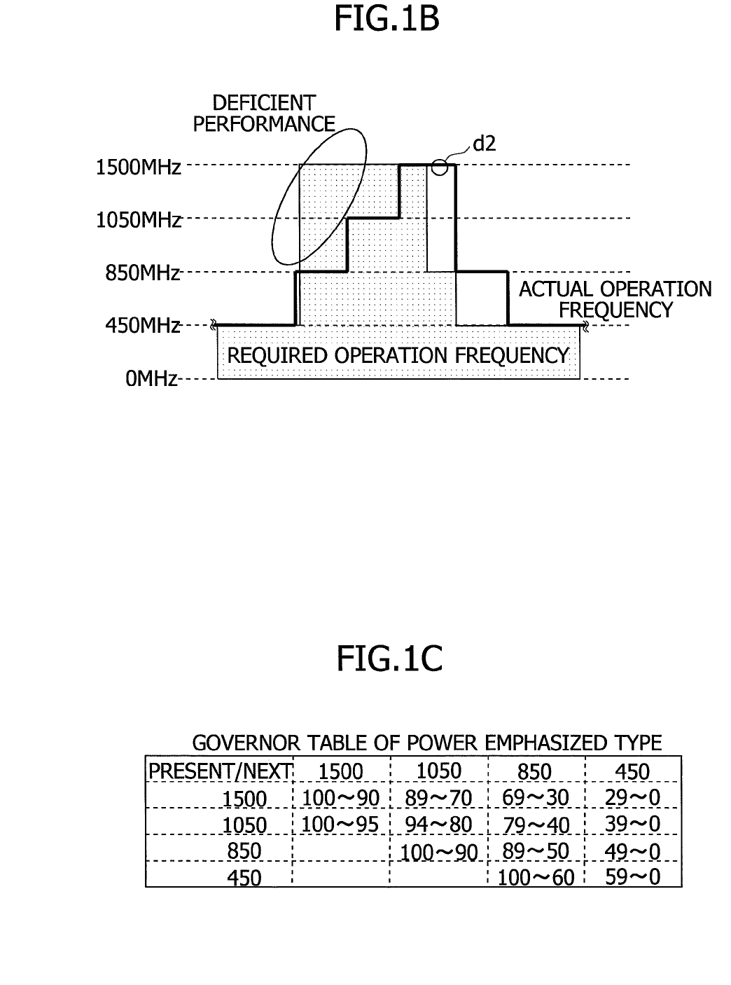

The information processing apparatus will hereinafter be described based on the drawings in FIGS. 1 through 13.

### Comparative Example

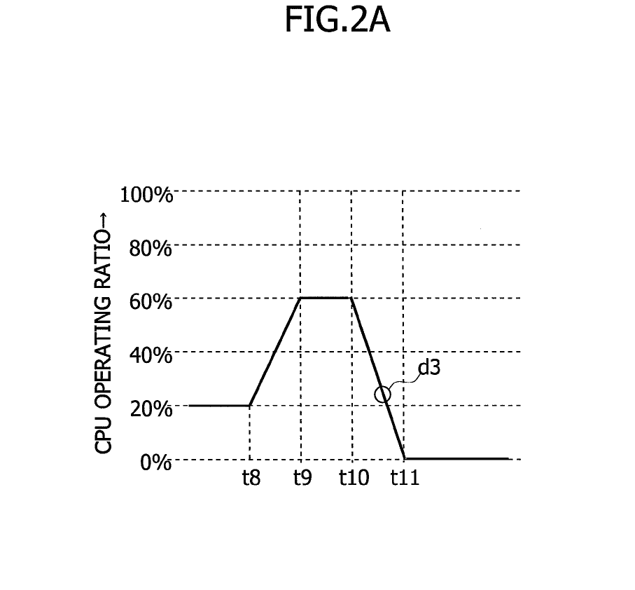

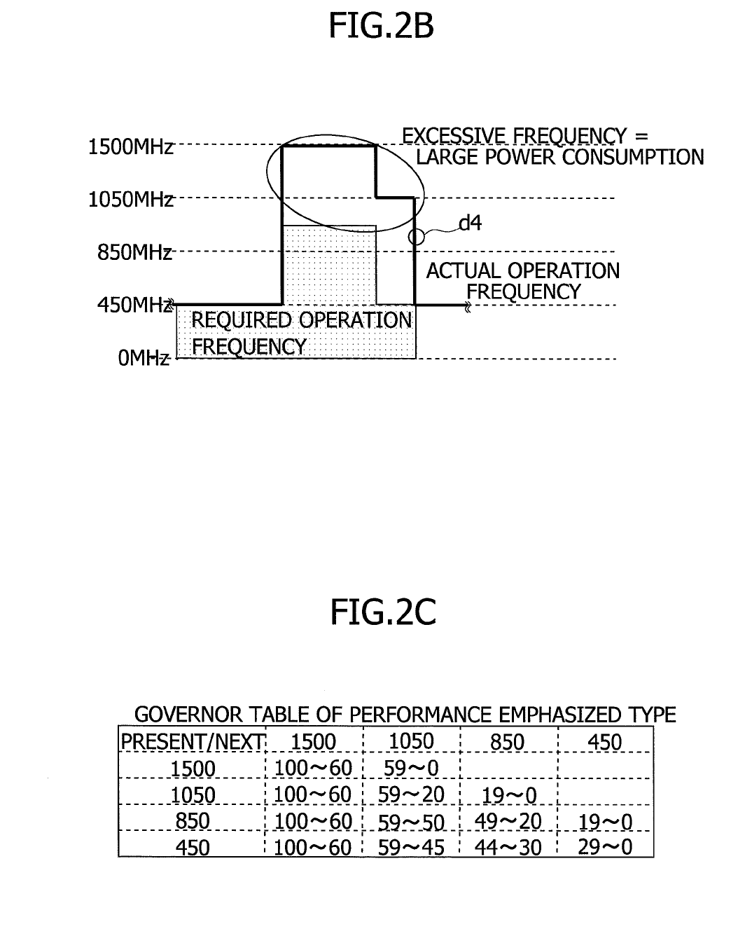

FIGS. 1A-1C and 2A-2C illustrate explanatory diagrams for explaining a relationship between a CPU operating ratio of the information processing apparatus and a clock frequency supplied to peripheral processing circuits etc including the CPU. Herein, the information processing apparatus includes portable information processing apparatuses such as a smart phone, a tablet PC (PC: Personal Computer) and a PDA (Personal Data Assistance).

This type of information processing apparatus is configured to have higher-level function and performance and is thereby enabled to perform high-speed and large-capacity data processing. The information processing apparatus executes a variety of applications and screen operations in accordance with user's instructions inputted via, e.g., a touch panel mounted as an input device. The information processing apparatus performs the high-speed and large-capacity data processing that accompanies executing the variety of applications and thus enables users to view and listen to contents such as on-line moving pictures with a high resolution, the contents being provided via, e.g., a browser function. Further, the information processing apparatus capable of receiving terrestrial digital television broadcasting services enables the users to view and listen to the contents with the high resolution, the contents being provided with high-definition videos and voices on a full-segment basis. Further, for example, in the case of participating in an on-line game via the information processing apparatus, this information processing apparatus successively displays delivered game scenes and can transmit the touch-operation based instructions of the user to a content provider site, corresponding to the displayed game scenes.

Thus-configured information processing apparatus is capable of executing the high-speed and large-capacity data processing and is therefore equipped with high-function and high-performance processors and peripheral circuits. The high-performance processors can be exemplified by processors each having an operation frequency over 1 GHz, multi-core processors configured by incorporating a plurality of cores into a single CPU package, and so on.

The information processing apparatus configured to have the higher-level function and performance described above has a tendency that power consumption related to processing of the content rises. For restraining the increasing power consumption, with respect to the information processing apparatus capable of the high-speed and large-capacity data processing, an information processing apparatus is proposed, which is set to decrease a drive voltage of the processor and also the operation frequency of each of the peripheral circuits including the processor when a load of the processor is small. Thus, e.g., DVFS (Dynamic Voltage Frequency Scaling) can be exemplified as a technology of retraining the power consumption through the setting to decrease the drive voltage of the processor and also the operation frequency of each of the peripheral circuits including the processor when the load of the processor is small.

For example, power consumption P of the information processing apparatus can be expressed in the following formula (1).

$$P = {\int }_{0}^{t} \{ C \times {( {V}_{DD} )}^{2} \times fc + {V}_{DD} \times {I}_{lkg} \} d t \qquad ( 1 )$$

where,
V_{DD}: voltage
fc: frequency,
C: electrostatic capacity, and
I_{lkg}: leak current

From the formula (1), the power consumption of the information processing apparatus can be divided into “∫[C×(V_{DD})²×fc]dt” defined as dynamic consumption and “∫V_{DD}×I_{1kg}dt” defined as consumption derived from the leak current. It is understood that the power consumption of the information processing apparatus increases in proportion to the voltage (V_{DD}) and the frequency (fc). Then, it is comprehended that the dynamic power consumption of the information processing apparatus is proportional to a square of the voltage (V_{DD}) and the frequency (fc). Namely, it is understood that the information processing apparatus can restrain the power consumption through the operation to reduce the drive voltage of the processor and the operation frequency.

In the information processing apparatus having the DVFS function, e.g., the operation frequency and the drive voltage of the processor etc. are set to take an entire balance between the performance and the power consumption related to a whole processing load of the information processing apparatus. Hence, the information processing apparatus involves ensuring the uniform performance and restraining the power consumption without depending on, e.g., the type of the application, the touch operation, etc., which causes the processing load.

Herein, the operation frequency can be defined by the clock frequency supplied to the processor etc. Then, the information processing apparatus having the DVFS function sets the drive voltage of the processor etc. down to a low clock frequency voltage when the processing load is low, and is thus operated at the low clock frequency, thereby restraining the power consumption related to the processing load. Further, the information processing apparatus having the DVFS function sets the drive voltage of the processor etc. up to a high clock frequency voltage when the processing load is high, and is thus operated at the high clock frequency, thereby ensuring the performance related to the processing load.

Note that it can be understood from the formula (1) that the power consumption related to the processing of the content can be restrained by reducing the number of cores to be operated when the load of the processor is small if the processor of the information processing apparatus includes the plurality of cores.

In the following discussion, control referred to as “governor control” represents a control method of ensuring the performance and restraining the power consumption related to the processing load of the information processing apparatus by dynamically setting, based on a table or a calculating formula, the operation frequency, the drive voltage, an operation core count, etc of the information processing apparatus. The governor control involves setting an operation frequency and an operation core count after a status of the processing load has varied on the basis of the operation frequency, the operation core count and the processing load of the processor that are given, e.g., at a point of time when processing the content. Note that in the following discussion, the setting of the operation frequency against the status variation of the processing load of the single processor by use of the table, is to be an explanatory example of the governor control.

The explanatory diagrams illustrated in FIGS. 1A-1C are explanatory diagrams for explaining the relationship between the CPU operating ratio and the clock frequency supplied to the peripheral processing circuits including the CPU in, e.g., a power emphasized type of emphasizing the restraint of the power consumption of the information processing apparatus. Further, the explanatory diagrams illustrated in FIGS. 2A-2C are explanatory diagrams for similarly explaining the relationship between the CPU operating ratio and the clock frequency supplied to the peripheral processing circuits including the CPU in, e.g., a performance emphasized type of emphasizing the performance of the information processing apparatus.

The axis of ordinates in FIG. 1A indicates the CPU operating ratio representing the processing load of the processor of the information processing apparatus, while the axis of abscissas indicates the time. In FIG. 1A, a graph d1 represents a transition example of the processing load of the processor of the information processing apparatus with respect to a user's operation such as a flick. Moreover, the axis of ordinates in FIG. 1B indicates the clock frequency representing the operation frequency of the information processing apparatus, while the axis of abscissas indicates the time. In FIG. 1B, a graph d2 represents a transition example of the operation frequency in the information processing apparatus with respect to the processing load in FIG. 1A. Furthermore, in FIG. 1B, an area indicated by hatching exemplifies the operation frequency enabling the performance to be ensured with respect to the processing load. Additionally, FIG. 1C illustrates a table example of the power emphasized type, in which the processing load and the operation frequency of the information processing apparatus are associated with each other. In the table example of FIG. 1C, the operation frequency of the information processing apparatus is set at four stages of “450 MHz”, “850 MHz”, “1050 MHz” and “1500 MHz”.

The operation frequency of the information processing apparatus is controlled based on, e.g., the table illustrated in FIG. 1C, and, as a result, the information processing apparatus gets the operation frequency to transition stepwise in the way of being associated with the variations of the processing load as depicted in FIG. 1B. Note that in the following discussion, as illustrated in FIGS. 1C and 2C, the table (governor) for setting the operation frequencies in the way of being associated with the variations of the processing load of the information processing apparatus is also termed a “governor table”. Further, the description will be made on the assumption that in the governor table illustrated in FIGS. 1C and 2C, a high or low level of the drive voltage of the processor etc. is set corresponding to a high or low level of the operation frequency to be set. For example, 3-stage voltage setting such as a high clock frequency voltage, an intermediate clock frequency voltage and a low clock frequency voltage can be exemplified as the setting of the drive voltage of the processor etc. In the 3-stage voltage setting, in the case of setting the operation frequency of, e.g., “1500” MHz, the high clock frequency voltage exhibiting a relatively high voltage value is set as the drive voltage. Further, in the case of setting the operation frequency of, e.g., “450” MHz, the low clock frequency voltage exhibiting a relatively low voltage value is set as the drive voltage. Then, in the case of setting the operation frequencies of, e.g., “1050” MHz and “850” MHz, the intermediate clock frequency voltages between the high clock frequency voltage and the low clock frequency voltage are set as the drive voltages.

In the example of FIG. 1A, the processing load of the processor of the information processing apparatus when performing the flick operation transitions such as (t1, 20%)→(t2, 100%)→(t3, 100%)→(t4, 100%)→(t5, 60%)→(t6, 60%)→(t7, 0%). It is to be noted that “tx (x=1 to 7) is normalized time, and “XXX=0 to 100” is the CPU operating ratio.

With respect to the transitions of the processing load of the processor that accompany the flick operation as illustrated in FIG. 1A, the operation frequency of the information processing apparatus set in the power emphasized type transitions stepwise as illustrated in FIG. 1B. The operation frequency of the information processing apparatus set to the power emphasized type transitions stepwise based on the governor table depicted in FIG. 1C.

In the governor table of FIG. 1C, a vertical line of a “present/next” column indicates, e.g., the operation frequency of the information processing apparatus being operated underway, while a horizontal line of the “present/next” column indicates, e.g., the operation frequency that transitions corresponding to the variations of the processing load of the information processing apparatus. A state quantity of the processing load is set as a condition for the operation frequency to transition in a column at an intersection between the vertical line of the “present/next” column and the horizontal line of the “present/next” column. In the example of FIG. 1C, the state quantity of the processing load of the information processing apparatus is associated with, e.g., the CPU operating ratio (%). The information processing apparatus sets the operation frequency associated with a variation of the state quantity of the processing load, when performing the flick operation, on the basis of, e.g., the operation frequency and the CPU operating ratio at the present point of time.

For instance, in the example of FIG. 1A, the CPU operating ratio as the processing load at timing t1 is 20%. If the operation frequency of the information processing apparatus before the timing t1 is assumed to be 450 MHz, the information processing apparatus sets the operation frequencies from the timing t1 onward on the basis of the governor table illustrated in FIG. 1C from the CPU operating ratio of 20% and the operation frequency of 450 MHz at the timing t1. The state quantities “100-60” and “59-0” are stored each as the condition for the operation frequency to transition in a row associated with a “450” column in the vertical line of the “present/next” column of the governor table in FIG. 1C. Each of the state quantities “100-60” and “59-0” represents a range of CPU operating ratio.

The information processing apparatus, when detecting the CPU operating ratios of “100-60” and “59-0” as variations of the state quantity of the processing load, sets the operation frequencies associated with the respective ranges of the CPU operating ratio as new operation frequencies after the variations of the state quantity. In the example of FIG. 1C, the range of CPU operating ratio of “100-60” is associated with the operation frequency of “850” MHz being set after the variations of the state quantity. Further, similarly, the range of CPU operating ratio of “59-0” is associated with the operation frequency of “450” MHz being set after the variations of the state quantity. The CPU operating ratio at the timing t1 in FIG. 1A is 20% and is included in the range of CPU operating ratio such as “59-0”% in FIG. 1C. Therefore, the information processing apparatus newly sets the operation frequency of “450” MHz in order to correspond to the variation of the state quantity at the timing t1.

Further, in the example of FIG. 1A, the processing load of the processor of the information processing apparatus rises monotonously, and the CPU operating ratio of 100% is attained at timing t2. The information processing apparatus detects the variation of the CPU operating ratio from, e.g., the timing t1 to the timing t2, and sets the operation frequency corresponding to the variation of the state quantity on the basis of the governor table in FIG. 1C. For example, the CPU operating ratio at the timing t2 in FIG. 1A is 100% and is included in the range of CPU operating ratio of “100-60” in FIG. 1C. Hence, in the information processing apparatus being operated underway at “450” MHz, the operation frequency of “850” MHz is newly set in order to correspond to the variation of the state quantity at the timing t2.

Moreover, in the example of FIG. 1A, the CPU operating ratio becoming 100% at the timing t2 is kept during a period till reaching timing t4. The information processing apparatus similarly detects the variations of the CPU operating ratio from the timing t2 to the timing t3 and from the timing t3 to the timing t4, and sets the operation frequencies corresponding to the variations of the state quantities on the basis of the governor table in FIG. 1C.

The state quantities “100-90” and “89-50” and “49-0” defined as the ranges of the CPU operating ratio are stored at 3-stages as the condition for the operation frequency to transition in a row associated with a “850” column in the vertical line of the “present/next” column of the governor table in FIG. 1C. The range of CPU operating ratio of “100-90” in FIG. 1C is associated with the operation frequency of “1050” MHz being set after the variation of the state quantity, and the range of CPU operating ratio of “89-50” is associated with the operation frequency of “850” MHz. Moreover, the range of CPU operating ratio of “49-0” in FIG. 1C is associated with the operation frequency of “450” MHz. The CPU operating ratio at the timing t3 in FIG. 1A is 100% and is included in the range of CPU operating ratio of “100-60” in FIG. 1C. Hence, in the information processing apparatus being operated underway at “850” MHz, the operation frequency of “1050” MHz is newly set in order to correspond to the variation of the state quantity at the timing t3.

In the information processing apparatus set at the operation frequency of “1050” MHz, a new operation frequency is set based on the governor table in FIG. 1C in order to correspond to the CPU operating ratio at the timing t4. The state quantities “100-95”, “94-80”, “79-40” and “39-0” defined as the ranges of the CPU operating ratio are stored at 4-stages as the condition for the operation frequency to transition in a row associated with a “1050” column in the vertical line of the “present/next” column of the governor table in FIG. 1C. The range of CPU operating ratio of “100-90” in FIG. 1C is associated with the operation frequency of “1500” MHz being set after the variation of the state quantity, and the range of CPU operating ratio of “94-80” is associated with the operation frequency of “1050” MHz. Similarly, the range of CPU operating ratio of “79-40” in FIG. 1C is associated with the operation frequency of “850” MHz, and the range of CPU operating ratio of “39-0” is associated with the operation frequency of “450” MHz.

In the example of FIG. 1A, the CPU operating ratio at the timing t4 is 100% and is included in the range of CPU operating ratio of “100-95” in FIG. 1C. Therefore, in the information processing apparatus being operated underway at “1050” MHz, the operation frequency of “1500” MHz is newly set in order to correspond to the variation of the state quantity at the timing t4.

Next, in the example of FIG. 1A, the processing load of the processor of the information processing apparatus at timing t5 monotonously decreases from 100% down to 60% and is kept during a period till reaching timing t6. In the information processing apparatus set at the operation frequency of “1500” MHz, a new operation frequency is set based on the governor table in FIG. 1C in order to correspond to the CPU operating ratio at the timing t5. The state quantities “100-90”, “89-70”, “69-30” and “29-0” defined as the ranges of the CPU operating ratio are stored at the 4-stages as the condition for the operation frequency to transition in a row associated with a “1500” column in the vertical line of the “present/next” column of the governor table in FIG. 1C. The CPU operating ratio at the timing t5 in FIG. 1A is 60% and is included in the range of CPU operating ratio of “69-30” in FIG. 1C. Accordingly, in the information processing apparatus being operated underway at “1500” MHz, the operation frequency of “850” MHz associated with the range of CPU operating ratio of “69-30” is newly set in order to correspond to the variation of the state quantity at the timing t5.

Then, in the information processing apparatus set at the operation frequency of “850” MHz, a new operation frequency is set based on the governor table in FIG. 1C in order to correspond to the CPU operating ratio at the timing t6. The state quantities “100-90”, “89-50” and “49-0” defined as the ranges of the CPU operating ratio are stored at the 3-stages as the condition for the operation frequency to transition in the row associated with the “850” column in the vertical line of the “present/next” column of the governor table in FIG. 1C. The CPU operating ratio at the timing t6 in FIG. 1A is 60% and is included in the range of CPU operating ratio of “89-50” in FIG. 1C. Therefore, in the information processing apparatus being operated underway at “850” MHz, the operation frequency of “850” MHz associated with the range of CPU operating ratio of “89-50” is newly set in order to correspond to the variation of the state quantity at the timing t6. In the information processing apparatus, the operation frequency of “850” MHz is kept during the variation of the state quantity from the timing t5 to the timing t6.

Furthermore, in the example of FIG. 1A, the processing load of the processor of the information processing apparatus at timing t7 monotonously decreases from 60% down to 0%. In the information processing apparatus set at the operation frequency of “850” MHz, a new operation frequency is set based on the governor table in FIG. 1C in order to correspond to the CPU operating ratio at the timing t7. The CPU operating ratio at the timing t7 in FIG. 1A is 0% and is included in the range of CPU operating ratio of “49-0” in FIG. 1C. Hence, in the information processing apparatus being operated underway at “850” MHz, the operation frequency of “450” MHz associated with the range of CPU operating ratio of “49-0” is newly set in order to correspond to the variation of the state quantity at the timing t7.

Thus, the operation frequency of the information processing apparatus set in the power emphasized type illustrated in FIGS. 1A-1C transitions so as to increase stepwise with respect to the rise in processing load as depicted in FIG. 1B. In the information processing apparatus set in the power emphasized type, the operation frequency transitions so as to increase stepwise with respect to the rise in processing load, thereby restraining the power consumption accompanying the operation at the high clock frequency. For example, the governor table in FIG. 1C has no setting of the CPU operating ratio for the operation frequency to transition from “450” MHz to “1500” MHz and “1050” MHz. Further, similarly, as illustrated therein, the governor table has no setting of the CPU operating ratio for the operation frequency to transition from “850” MHz to “1500” MHz. Hence, as illustrated in FIG. 1B, it follows that a frequency difference occurs between the operation frequency for ensuring the performance and the operation frequency set with respect to the processing load. In the example of FIG. 1B, during a period of the transition from the timing t2 to the timing t4 for which the CPU operating ratio becomes 100%, the frequency difference occurs between the operation frequency of “1500” MHz for fulfilling the performance and the operation frequency set with respect to the processing load. For example, in an area with the occurrence of the frequency difference in FIG. 1B, the information processing apparatus is unable to ensure the performance satisfactory to the rise in processing load. Therefore, for instance, in an application involving frequent flick operations etc. for scrolling the display area of the content displayed on the information processing apparatus, such a state can occur that scrolling is performed in a way that the display area does not catch up scrolling. The user of the information processing apparatus feels unsatisfactory about a throughput etc such as operability and responsibility of the information processing apparatus as the case may be.

Moreover, similarly, the operation frequency of the information processing apparatus set in the power emphasized type transitions so as to decrease stepwise with respect to a reduction in processing load. For instance, in the example of FIG. 1B, during a period of the transition from the timing t4 to the timing t7 for which the CPU operating ratio becomes 0% from 100%, there exists an area where the operation frequency is set high for the processing load. In the information processing apparatus set in the power emphasized type, the frequency difference occurs between the operation frequency set with respect to the processing load and the operation frequency for ensuring the performance. The area with the occurrence of the frequency difference causes excessive power consumption due to the operation at the high clock frequency. Therefore, the information processing apparatus set in the power emphasized type has a tendency to reduce an effect in restraining the power consumption.

Next, the information processing apparatus of the performance emphasized type that emphasizes the performance will hereinafter be described with reference to explanatory diagrams of FIGS. 2A-2C. The axis of ordinates in FIG. 2A indicates the CPU operating ratio representing the processing load of the processor of the information processing apparatus, while the axis of abscissas indicates the time. In FIG. 2A, a graph d3 represents a transition example of the processing load of the processor of the information processing apparatus with respect to a user's operation such as a tap. The axis of ordinates in FIG. 2B indicates the clock frequency representing the operation frequency of the information processing apparatus, while the axis of abscissas indicates the time. In FIG. 2B, a graph d4 represents a transition example of the operation frequency in the information processing apparatus. In FIG. 2B, an area indicated by hatching exemplifies the operation frequency enabling the performance to be ensured with respect to the processing load. FIG. 2C, similarly to FIG. 1C, illustrates a governor table example of the performance emphasized type, in which the processing load and the operation frequency of the information processing apparatus are associated with each other. In the example of FIG. 2C also, similarly to FIG. 1C, the operation frequency of the information processing apparatus is set at the four stages of “450 MHz”, “850 MHz”, “1050 MHz” and “1500 MHz”. Further, contents of the respective columns in the governor table in FIG. 2C are the same as those in FIG. 1C, and hence their explanations are omitted.

In contrast with a transition of the processing load of the processor that accompanies the tap operation, as depicted in FIG. 2A, the operation frequency of the information processing apparatus set in the performance emphasized type transitions, as depicted in FIG. 2B, steeply with respect to the rise in processing load. The operation frequency of the information processing apparatus set in the performance emphasized type transitions based on the governor table illustrated in FIG. 2C.

In the example of FIG. 2A, the processing load of the processor of the information processing apparatus when performing the tap operation transitions such as (t8, 20%)→(t9, 60%)→(t10, 60%)→(t11, 0%). Herein, “tx (x=8 to 11) is normalized time, and “XXX % (XXX=0 to 100)” is the CPU operating ratio. Moreover, the operation frequency of the information processing apparatus before timing t8 is to be, e.g., 450 MHz.

The information processing apparatus sets, e.g., the operation frequency corresponding to the variation of the state quantity when performing the tap operation on the basis of the governor table depicted in FIG. 2C from the CPU operating ratio of 20% at the timing t8 and from the operation frequency of 450 MHz before the timing t8.

The state quantities “100-60”, “59-45”, “44-30” and “29-0” defined as the ranges of the CPU operating ratio are stored at the 4-stages as the condition for the operation frequency to transition in a row associated with a “450” column in the vertical line of the “present/next” column of the governor table in FIG. 2C. The range of CPU operating ratio of “100-60” in FIG. 2C is associated with the operation frequency of “1500” MHz being set after the variation of the state quantity, and the range of CPU operating ratio of “59-45” is associated with the operation frequency of “1050” MHz. Further, the range of CPU operating ratio of “44-30” in FIG. 2C is associated with the operation frequency of “850” MHz, and the range of CPU operating ratio of “29-0” is associated with the operation frequency of “450” MHz. The CPU operating ratio at the timing t8 is 20% in FIG. 2A and is included in the range of CPU operating ratio of “29-0” in FIG. 2C. Therefore, in the information processing apparatus being operated underway at “450” MHz, the operation frequency of “450” MHz is newly set in order to correspond to the variation of the state quantity at the timing t8. In the information processing apparatus, the operation frequency of “450” MHz is kept during the variation of state quantity from before the timing t8 to the timing t8.

Next, in the example of FIG. 2A, the processing load of the processor of the information processing apparatus rises monotonously, and the CPU operating ratio of 60% is attained at timing t9 and is kept during a period till reaching timing t10. In the information processing apparatus set at the operation frequency of “450” MHz, a new operation frequency is set based on the governor table in FIG. 2C in order to correspond to the CPU operating ratio at the timing t9.

The CPU operating ratio at the timing t9 in FIG. 2A is 60% and is included in the range of CPU operating ratio of “100-60” in FIG. 2C. Therefore, in the information processing apparatus being operated underway at “450” MHz, the operation frequency of “1500” MHz associated with the range of CPU operating ratio of “100-60” is newly set in order to correspond to the variation of the state quantity at the timing t9. In the information processing apparatus, the operation frequency of “450” MHz transitions to “1500” MHz during the variation of the state quantity from the timing t8 to the timing t9.

Next, in the information processing apparatus set at the operation frequency of “1500” MHz, a new operation frequency is set based on the governor table in FIG. 2C in order to correspond to the CPU operating ratio at the timing t10. The state quantities “100-60” and “59-0” defined as the ranges of the CPU operating ratio are stored at the 2-stages as the condition for the operation frequency to transition in a row associated with a “1500” column in the vertical line of the “present/next” column of the governor table in FIG. 2C. The range of CPU operating ratio of “100-60” in FIG. 2C is associated with the operation frequency of “1500” MHz being set after the variation of the state quantity, and the range of CPU operating ratio of “59-0” is associated with the operation frequency of “1050” MHz. The information processing apparatus set in the performance emphasized type has no setting of the state quantity of the processing load with respect to the operation frequency such as “850” MHz and “450” MHz in order to keep the performance at the operation frequency set at “1050” MHz.

The CPU operating ratio at the timing t10 in FIG. 2A is 60% and is included in the range of CPU operating ratio of “100-60” in FIG. 2C. Accordingly, in the information processing apparatus being operated underway at “1500” MHz, the operation frequency of “1500” MHz associated with the range of CPU operating ratio of “100-60” is newly set in order to correspond to the variation of the state quantity at the timing t10. Namely, the information processing apparatus continues to keep the state of the operation frequency of “1500” MHz, which is the highest frequency at the timing t10 also.

Next, in the example of FIG. 2A, the processing load of the processor of the information processing apparatus at timing t11 monotonously decreases from 60% down to 0%. In the information processing apparatus set at the operation frequency of “1500” MHz, a new operation frequency is set based on the governor table in FIG. 2C in order to correspond to the CPU operating ratio at the timing t11. The CPU operating ratio at the timing t11 in FIG. 2A is 0% and is included in the range of CPU operating ratio of “59-0” of “1500” MHz in FIG. 2C. Hence, in the information processing apparatus being operated underway at “1500” MHz, the operation frequency of “1050” MHz associated with the range of CPU operating ratio of “59-0” is newly set in order to correspond to the variation of the state quantity at the timing t11.

In FIG. 2A, the CPU operating ratio from the timing t11 onward continues to keep the state of 0%, in which case the information processing apparatus set at the operation frequency of “1050” MHz further sets a new operation frequency on the basis of the governor table in FIG. 2C. To be specific, the state quantities “100-60”, “59-20” and “19-0” defined as the ranges of the CPU operating ratio are stored at the 3-stages as the condition for the operation frequency to transition in a row associated with a “1050” column in the vertical line of the “present/next” column of the governor table in FIG. 2C. At first, from the timing t11 onward, in the information processing apparatus, the CPU operating ratio continues to keep the state of 0%, and hence the operation frequency of “850” MHz in FIG. 2C associated with the range of CPU operating ratio of “19-0” of “1050” MHz is newly set. Then, in the information processing apparatus set at the operation frequency of “850” MHz, the operation frequency is set “450” MHz associated with the range of CPU operating ratio of “19-0” in the row associated with the “850” MHz column in the vertical line of “present/next” column in the governor table in FIG. 2C.

Thus, the operation frequency of the information processing apparatus, illustrated in FIGS. 2A-2C, set in the performance emphasized type transitions steeply with respect to the rise in processing load as illustrated in FIG. 2B. For example, in the information processing apparatus, it follows that the operation frequency of “1500” MHz exhibiting the highest performance is set even if an allowance is still left such as when the CPU operating ratio is 60%. Therefore, for instance, as at the timing t9-timing t10 in FIG. 2B, the frequency difference occurs between the operation frequency equivalent to the processing load and the operation frequency of the information processing apparatus set in the performance emphasized type. Moreover, the operation frequency of the information processing apparatus set in the performance emphasized type transitions stepwise with respect to the decrease in processing load. For example, as from the timing t10 onward, it follows that there is set the operation frequency such as “1050” MHz and “850” MHz exhibiting the excessive performance for the CPU operating ratio even when the CPU operating ratio becomes 0%. In the information processing apparatus set in the performance emphasized type, such an area exists that the operation frequency is set high for the processing load. In the area with the occurrence of the frequency difference, the power consumption accompanying the operation at the high clock frequency becomes excessive. Consequently, in the information processing apparatus set in the performance emphasized type also, the effect in restraining the power consumption is reduced.

For example, in the application configured to stand by for an input of the user's operation such as the tap operation about the displayed content, a state of setting the excessive performance with respect to the processing load can occur. The information processing apparatus remaining in the state of setting the excessive performance with respect to the processing load has a tendency of reducing the effect in restraining the power consumption.

Moreover, for instance, in the application involving the frequent flick operations etc. for scrolling the display area of the content displayed on the information processing apparatus, there is no possibility that scrolling is performed in a way that the display area does not catch up scrolling because of giving priority to the performance. Even on and after a stop of the scrolling operation over the display, the information processing apparatus set in the performance emphasized type sets the excessive operation frequency for the CPU operating ratio and therefore has the tendency of reducing the effect in restraining the power consumption.

### Working Example

As described in the comparative example, under the governor control set to take the entire balance between the performance related to the processing load and the power consumption, such a state can occur that the performance becomes excessive or deficient for the type of the touch operation that entails executing the application. Further, under the governor control set to take the entire balance between the performance related to the processing load and the power consumption, similarly such a state can occur that the effect in restraining the power consumption decreases for the type of the touch operation that entails executing the application.

The information processing apparatus according to the embodiment is configured to specify the type of the touch operation accompanying the execution of the application and to perform the governor control suited to the specified type of the touch operation, thereby improving the effect in restraining the power consumption. Further, the information processing apparatus according to the embodiment is configured to perform the governor control suited to the type of the touch operation accompanying the execution of the application, thereby ensuring the performance suited to the execution of the application.

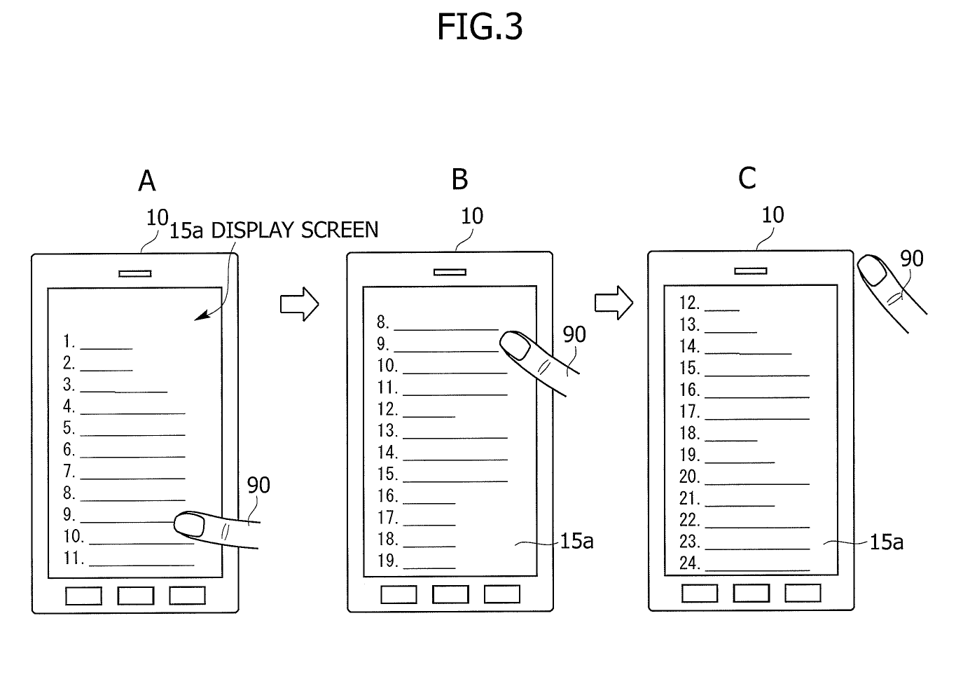

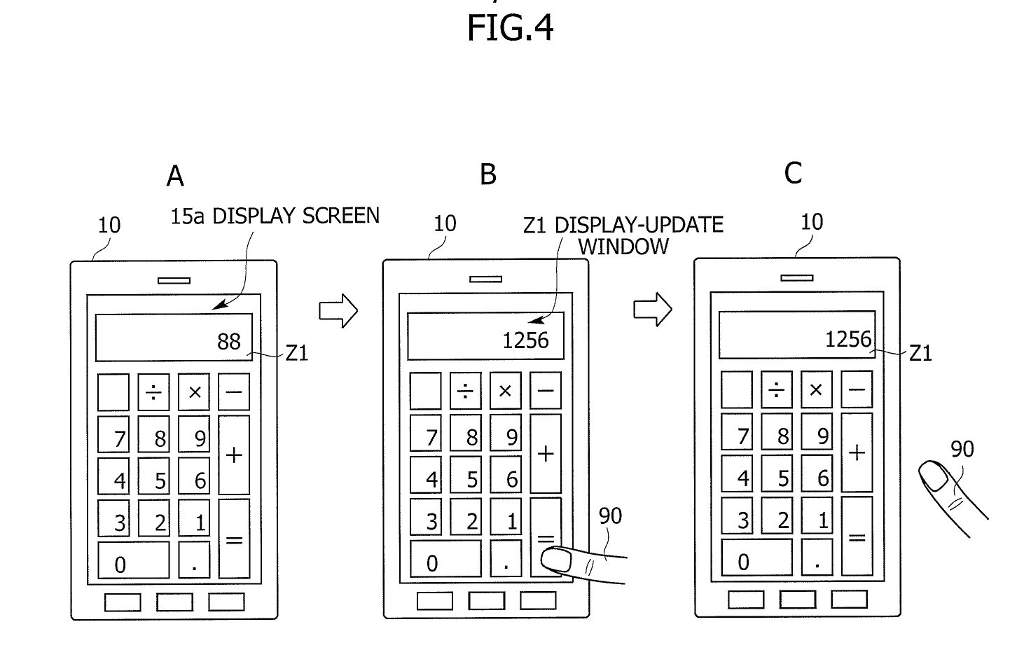

FIGS. 3 and 4 illustrate explanatory diagrams related to the flick operation and the tap operation on the information processing apparatus. FIG. 3 is the explanatory diagram related to the flick operation when using, e.g., a browser application as the application involving the frequent use of the flick operations. Moreover, FIG. 4 is the explanatory diagram related to the tap operation when using, e.g., an electronic calculator application as the application involving the frequent use of the tap operations. Note that in the explanatory diagrams of FIGS. 3 and 4, an information processing apparatus 10 is defined as the information processing apparatus according to the embodiment.

In the explanatory diagram of FIG. 3, e.g., a display screen displayed on a touch panel 15a of the information processing apparatus 10, which accompanies the flick operation of the user, consecutively varies in a time-series sequence such as “A”→“B”→“C”. FIG. 3A illustrates, e.g., a status in which the user of the information processing apparatus 10 starts up the browser application and displays a downloaded content on the touch panel 15a. The content downloaded via the browser application of the information processing apparatus is displayed in a maximum display area that can be displayed by the touch panel 15a.

In FIG. 3A, the user of the information processing apparatus 10, who scrolls the display area of the displayed content, gets an operation finger 90 such as an index finger and a middle finger touching the content in superposition, the content being displayed on the touch panel 15a. Then, as depicted in FIG. 3B, the user performing the flick operation moves the operation finger 90 kept touching the content in superposition while sliding on the touch panel 15a, the content being displayed on the touch panel 15a. The display area of the content displayed on the touch panel 15a follows the movement of the operation finger 90 and is thus scrolled, in which a starting point is a touch position of the operation finger 90 in FIG. 3A.

For instance, in the example of FIG. 3A, the operation finger 90 touches in superposition a display field indicated by “9” of the content displayed on the touch panel 15a. The display field indicated by “9” is located in a third display position counted from a lower edge of the content displayed on the touch panel 15a. Then, as depicted in FIG. 3B, the display field indicated by “9” of the content displayed on the touch panel 15a follows the movement of the operation finger 90 and thus moves the display position of this display area. A moved display position indicated by “9” of the content is, as illustrated in FIG. 3B, located in a second display position counted from an upper edge of the content displayed on the touch panel 15a. With the movement of the display field, items of data of the contents accumulated in, e.g., a RAM (Random Access Memory) etc. are update-displayed on the touch panel 15a through a display process of the information processing apparatus 10.

Then, in FIG. 3C, the user performing the flick operation releases, e.g., the operation finger 90 kept so far moving while sliding on the touch panel 15a (smoothly) from on the touch panel 15a by moving the finger while continuously touching. As for the content displayed on the touch panel 15a, with the scroll continuing on and after the release of the operation finger 90 of the user from the touch panel 15a, the content displayed on the touch panel 15a is continuously update-displayed.

As illustrated in FIGS. 3A-3C, the flick operation is that the operation finger 90 kept touching the touch panel 15a moves while sliding and is released from on the touch panel 15a in the manner of flicking the moved operation finger 90. Therefore, the flick operation has a tendency exhibiting a faster touch-up motion of the operation finger 90 when the operation finger 90 kept so far touching the touch panel 15a releases from on the touch panel 15a.

Note that an operation similar to the flick operation is exemplified by a swipe operation as an operation for moving the display field of an image and suchlike displayed on the touch panel 15a. The swipe operation enables, e.g., the display position of the content to be moved within the display area that can be displayed on the touch panel 15a. For example, the user moves the operation finger 90 by sliding the finger along on the touch panel 15a up to the display position indicated by “9” depicted in FIG. 3B while keeping the finger touching the display position indicated by “9” depicted in FIG. 3A. Then, the user stops moving the operation finger 90 moved to the display position indicated by “9” depicted in FIG. 3B, and touches up the operation finger 90 kept touching in superposition the display position indicated by “9”. Hence, a motion of the swipe operation is different from the flick operation in terms of a moving speed of the operation finger when performing the touch-up operation. The user stops moving the operation finger 90 and touches up the finger in the swipe operation and, by contrast, touches up the operation finger 90 in the status of continuing the movement of the operation finger 90 in the flick operation.

Next, a motion of the tap operation will be described with reference to an explanatory diagram illustrated in FIG. 4. In the explanatory diagram of FIG. 4, the display screen displayed on the touch panel 15a of the information processing apparatus 10, which accompanies, e.g., the flick operation of the user, consecutively varies in the time-series sequence such as “A”→“B”→“C”. FIG. 4A illustrates a status in which the user of the information processing apparatus 10 starts up the electronic calculator application and displays display-components related to the electronic calculator on the touch panel 15a. A display area on the touch panel 15a when starting up the electronic calculator application contains a display-update window z1 and fixed display-components for inputting operations for the electronic calculator application. In FIG. 4A, the fixed display-components for inputting the operations for the electronic calculator application include, e.g., arithmetic components for designating classifications of arithmetic operations such addition, subtraction, multiplication and division, and also include numeric value components for designating input numeric values related to the arithmetic operations, etc. An arithmetic result given by the electronic calculator application is displayed in, e.g., the display-update window z1.

In FIG. 4B, the user of the information processing apparatus 10, who performs the arithmetic operation based on the electronic calculator application, gets the operation finger 90 such as the index finger and the middle finger touching in superposition the fixed display-component displayed on the touch panel 15a. Then, the user releases the operation finger 90 kept so far touching without moving the touch position from on the touch panel 15a, thereby inputting the tap operation related to the arithmetic operation. For example, the user performing the arithmetic operation such as “157×8” sequentially taps the respective numeric value components “1”, “5” and “7” with respect to the displayed the fixed display-components, then taps the arithmetic component “x”, subsequently taps arithmetic component “8” and taps the arithmetic component “=”. As a result, “1256” is displayed as the arithmetic result in the display-update window z1 as depicted in FIG. 4C. Note that input values related to the arithmetic operation, which are inputted by the tap operation of the user, are temporarily displayed in, e.g., the display-update window z1. Further, no update on the display screen is carried out during a repetition of the tap operations.

As depicted in FIGS. 4(a)-4(c), in the application involving the frequent use of the tap operations, tap-down and touch-up are repeated in the display field effective in executing the application. Therefore, the touch position of the operation finger 90 touching the touch panel 15a does not substantially move.

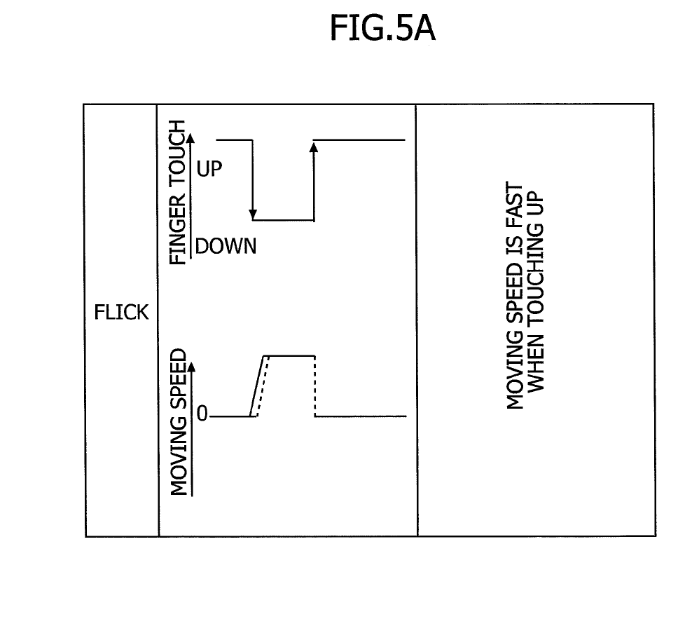

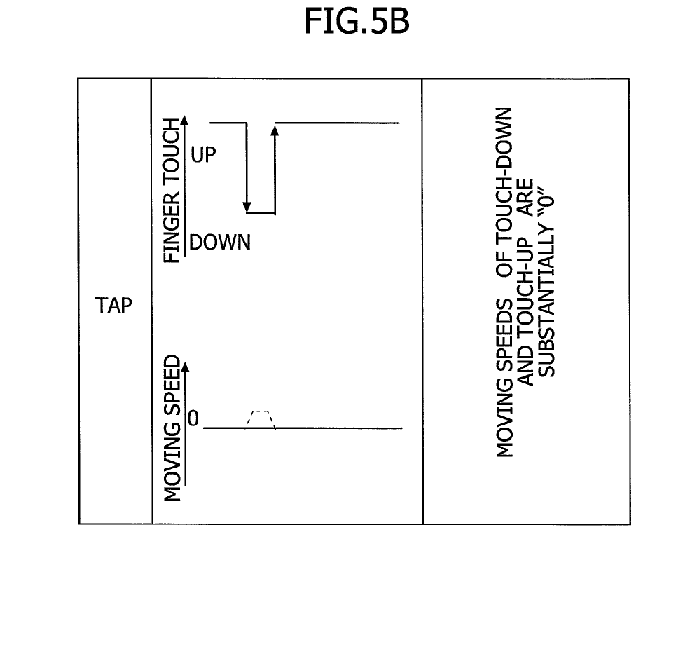

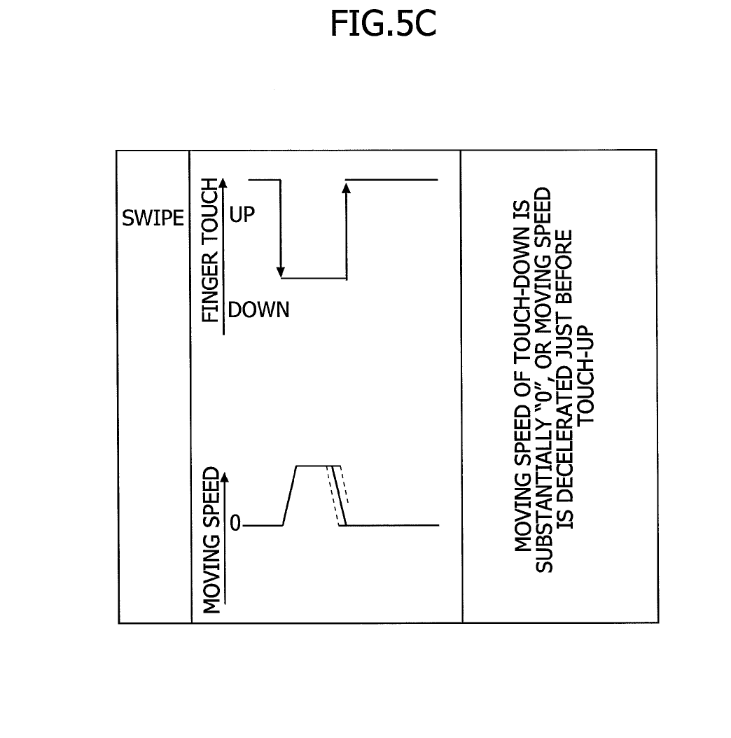

As explained in FIGS. 3 and 4, in the case of the occurrence of the tap operation accompanying the execution of the application, tendencies of the touch operations are displayed on a type-type basis as illustrated in, e.g., FIGS. 5A-5C. FIG. 5A is an explanatory diagram illustrating an operational tendency of the operation finger related to the flick operation. Similarly, FIG. 5B is an explanatory diagram illustrating an operational tendency of the operation finger related to the tap operation, and FIG. 5C is an explanatory diagram depicting an operational tendency of the operation finger related to the swipe operation.

As illustrated in FIG. 5A, the operation finger of the user performing the flick operation touches down the touch panel, and touches in superposition a display image displayed on the touch panel. Then, the user moves the operation finger in a scrolling direction while sliding on the touch panel, and touches up the operation finger kept so far touching from on the touch panel in the manner of flicking. As depicted in FIG. 5A, the operation finger touches up therefrom without decelerating the moving speed of the operation finger moving on the touch panel in the flick operation.

Next, in the tap operation, as illustrated in FIG. 5B, the operation finger of the user touches down on the display field in which to display, e.g., a predetermined image of the operation component etc. displayed on the touch panel, and touches in superposition the display field in which the predetermined image is displayed. Then, the operation finger kept so far touching in superposition on the display field is touched up without moving. Hence, the touch position of the operation finger touching the touch panel when performing the tap operation does not substantially move during the touching period. As depicted in FIG. 5A, in the tap operation, a speed of the movement, on the touch panel, of the operation finger from the touch-down to the touch-up becomes substantially “0”.

Further, in the swipe operation, as illustrated in FIG. 5C, the operation finger of the user touches down on the display image displayed on the touch panel, and touches in superposition the display position of the display image. Then, the operation finger touching the display position of the display image moves while sliding on the touch panel in the status to keep the touch on the display image, and stops moving in the display position as a moving target position within the display field enabling the display image to be displayed on the touch panel. The operation finger touching in superposition the display field touches up from on the touch panel in the display position as the moving target position after stopping the movement. As depicted in FIG. 5C, the swipe operation has a tendency of decelerating the moving speed just before the touch-up because of stropping the movement in the display position as the moving target position, and the moving speed when performing the touch-up becomes substantially “0”.

The information processing apparatus 10 according to the embodiment specifies the type of the touch operation accompanying the execution of the application from a timewise variation of status such as a moving distance of the touch position and the moving speed. Then, the information processing apparatus 10 according to the embodiment conducts the governor control corresponding to the specified type of the touch operation. Under the governor control according to the embodiment, in the case of, e.g., a single CPU, the operation frequency of the information processing apparatus, which is associated with the CPU load, is set corresponding to the type of the touch operation. Moreover, under the governor control according to the embodiment, in the case of having, e.g., the plurality of cores, the operation frequency and an operating core count of the information processing apparatus, which are associated with the CPU load, are set corresponding to the type of the touch operation. Therefore, under the governor control of the information processing apparatus 10 according to the embodiment, it is feasible to set the operation frequency and the operating core count suited to the touch operation accompanying the execution of the application. As a result, in the information processing apparatus 10 according to the embodiment, the operation frequency and the operating core count suited to the CPU load represented by the CPU operating ratio can be set, and it is therefore possible to improve the effect in restraining the power consumption and ensure the performance suited to the execution of the application. In the information processing apparatus 10 according to the embodiment, it is feasible to provide a technology of restraining the power consumption in the way suited to the application executed on the information processing apparatus 10.

[Architecture of Apparatus]

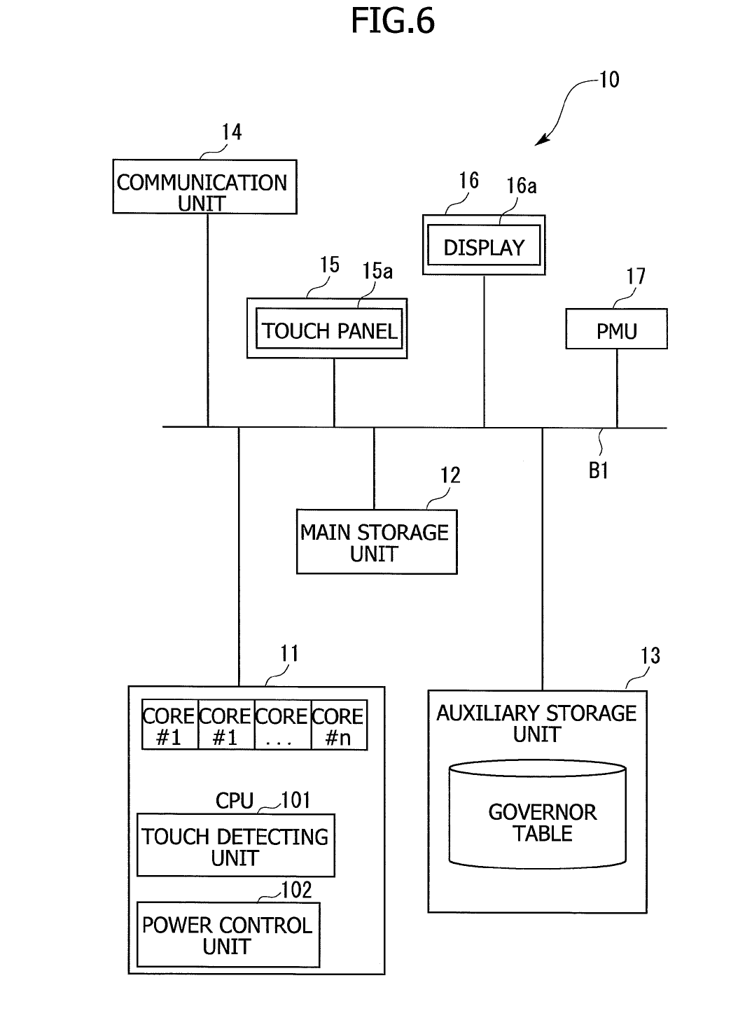

FIG. 6 illustrates hardware architecture of the information processing apparatus 10 according to the embodiment. The information processing apparatus 10 illustrated in FIG. 6 is a portable information processing apparatus such as the smart phone, the tablet PC and the PDA. The information processing apparatus 10 includes a CPU (Central Processing Unit) 11, a main storage unit 12, an auxiliary storage unit 13, a communication unit 14, an input unit 15, an output unit 16 and a PMU (Power Management Unit) 17, which are connected to each other via a connection bus B1. The main storage unit 12 and the auxiliary storage unit 13 are recording mediums readable by the information processing apparatus 10.

In the information processing apparatus 10, the CPU 11 deploys a program stored in the auxiliary storage unit 13 in an operating area of the main storage unit 12 in an execution-enabled mode, and controls peripheral devices through execution of the program. The information processing apparatus 10 is thereby enabled to realize a function matching with a predetermined purpose.

For example, the information processing apparatus 10 establishes a connection with a network such as the Internet via the communication unit 14 by use of the browser application etc, and thus enjoys a variety of ICT (Information & Communication Technology) services provided on the network. The variety of ICT services provided on the network can be exemplified such as transmission/reception of mails, participation in an SNS (Social Networking Service), distribution of information like disaster information etc., and downloading of games, videos, music, etc. Moreover, for instance, the information processing apparatus 10 capable of receiving the terrestrial digital television broadcasting services via the communication unit 14 can view and listen to the high-definition contents of the videos and the sounds provided by the full-segments with the high resolution.

The user of the information processing apparatus 10 displays, e.g., the downloaded display image on the output unit 16 of the information processing apparatus 10, and browses the contents provided on the network. The user of the information processing apparatus 10 moves the display field by scrolling the display image and inputs an instruction about the displayed content on the basis of the touch operation attained by touching the operation finger in superposition on the display image displayed when browsing, e.g., the content.

The information processing apparatus 10 according to the embodiment detects the touch operation accompanying, e.g., the execution of the application via the input device such as the touch panel 15a equipped in the input unit 15. Then, the information processing apparatus 10 according to the embodiment specifies the type of the touch operation from the timewise variation of status such as the moving distance of the touch position and the moving speed of the operation finger touching the touch panel 15a. Then, the information processing apparatus 10 conducts the governor control corresponding to the specified type of the touch operation.

In the information processing apparatus 10 illustrated in FIG. 6, the CPU 11 is the central processing unit that controls the information processing apparatus 10 as a whole. The CPU 11 is a multi-core processor configured by incorporating a plurality of cores into a single CPU package. The CPU 11 includes the plurality of cores and executes the high-speed and large-capacity data processing in a way that accompanies executing the variety of applications. Note that the CPU 11 may be configured as a single CPU and may also be configured as a multi-processor including a plurality of CPUs if being the processor capable of ensuring the performance involving the execution of the application.

The CPU 11 executes processing based on the program stored in the auxiliary storage unit 13. The main storage unit 12 is a storage medium on which the CPU 11 caches the program and the data and deploys the operating area. The main storage unit 12 includes, e.g., the RAM (Random Access Memory) and a ROM (Read Only Memory).

The auxiliary storage unit 13 stores various categories of programs and various items of data on the storage medium in a read-enabled/write-enabled manner. The auxiliary storage unit 13 is stored with an Operating System (OS), the various categories of programs, a variety of tables, etc. The OS contains a communication interface program for transferring and receiving the data to and from external devices connected via the communication unit 14. The external devices include, e.g., other information processing apparatuses, external storage devices, etc. on the connected network. Note that other information processing apparatuses include the information processing apparatuses each containing a voice-based telephone function and a communication function.

The auxiliary storage unit 13 is a memory card etc. such as an EPROM (Erasable Programmable ROM), a USB (Universal Serial Bus) memory and an eMMC (embedded Multi Media Card). Note that the auxiliary storage unit 13 may include, e.g., a solid-state drive device, a hard disk drive (HDD) device, etc. Further, the auxiliary storage unit 13 may also include a CD drive device, a DVD drive device, a BD drive device, etc. The non-transitory recording medium is exemplified such as a silicon disk including a nonvolatile semiconductor memory (flash memory), a hard disk, a CD, a DVD and BD.

The communication unit 14 is, e.g., an interface with the network and suchlike. The network, to which the information processing apparatus 10 is connected, includes, e.g., a public network such as the Internet, a wireless network such as a mobile phone network containing communication base stations, and so on.

The input unit 15 accepts the operation instructions and the like from the user etc. The input unit 15 is an input device such as, in addition to the touch panel 15a, a microphone, input buttons, input keys, a pointing device and a camera. The touch panel 15a, which is, e.g., an electrostatic capacity type of touch panel, detects a variation of electrostatic capacity between a conductive film of the touch panel 15a and the operation finger touching this conductive film, thus detecting the touch position of the operation finger. The CPU 11 is notified of information inputted from the input unit 15 via the connecting bus B1.

The output unit 16 outputs the data processed by the CPU 11 and the data stored in the main storage unit 12. The output unit 16 includes a display 16a like an LCD (Liquid Crystal Display) serving as the display device that displays the contents such as the display image. Note that the output unit 16 of the information processing apparatus 10 may include the display device like an EL (Electro luminescence) panel and an organic EL panel and an output device such as a speaker.

The PMU 17 includes a chargeable battery and supplies a power source related to the operation of the information processing apparatus 10. The PMU 17 supplies the drive voltage associated with the operation frequency set under the governor control to the CPU 11 and the peripheral circuits.

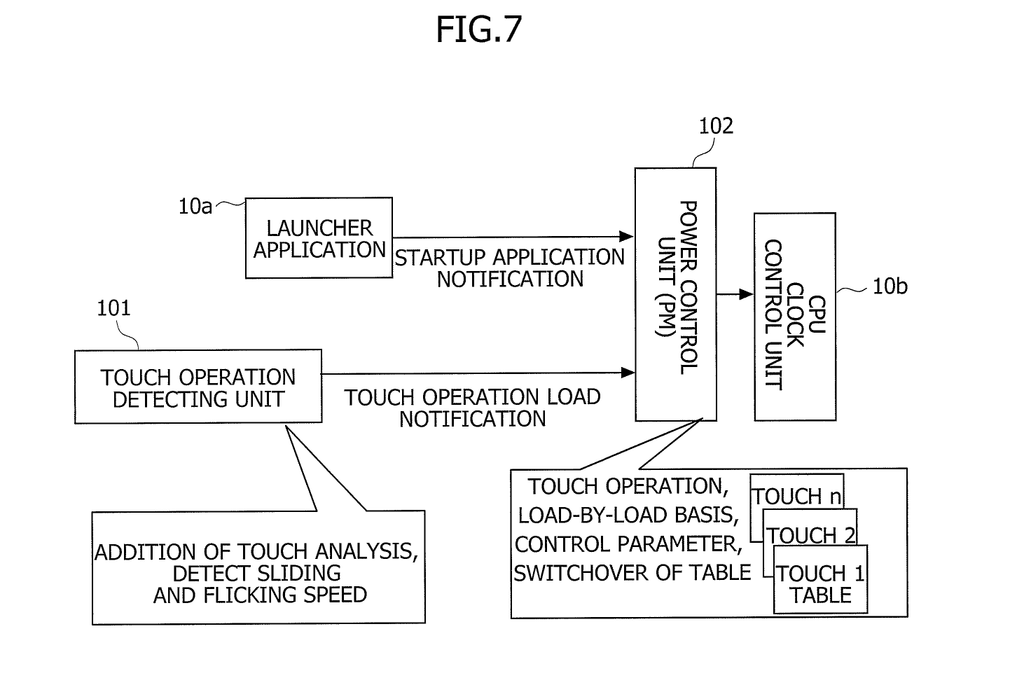

In the information processing apparatus 10 according to the embodiment, the CPU 11 reads the OS, the various categories of programs and the various items of data stored in the auxiliary storage unit 13 into the main storage unit 12 and executes the readout OS, programs and data. The information processing apparatus 10 acquires the CPU operating ratio together with executing a target program, and realizes functions of a touch operation detecting unit 101 and a power control unit 102 illustrated in FIG. 7.

### [Functional Configuration]

FIG. 7 illustrates an explanatory diagram for explaining the functions of the information processing apparatus 10 according to the embodiment. The information processing apparatus 10 illustrated in FIG. 7 includes respective function units of the touch operation detecting unit 101 and the power control unit 102. Note that a launcher application 10a in FIG. 7 is software to manage starting and finishing the variety of applications preinstalled in the information processing apparatus 10. Furthermore, a CPU clock control unit 10b is a function unit to control the operation frequencies of the peripheral circuits including the CPU. The CPU clock control unit 10b has a function to control the clock frequency supplied to the peripheral circuits including the CPU on the basis of the operation frequencies set in the governor tables illustrated in FIGS. 1C and 2C.

The touch operation detecting unit 101 detects a time-course variation of state quantity such as the touch position, the moving distance of the touch position and the moving speed each related to the touch operation accompanying, e.g., the execution of the application. The power control unit 102 is notified of the detected time-course variation of state quantity related to the touch operation.

A moving distance TR as the time-course variation of state quantity of the touch position related to the touch operation, which is detected by the touch operation detecting unit 101, can be expressed in the following formula (2). Further, similarly, a moving speed TV as the time-course variation of state quantity of the touch position related to the touch operation can be expressed in, e.g., the following formula (3).

TR=√(ΔX)2+(ΔY)2) (2)

TV=(√((ΔX)2+(ΔY)2))/ΔT (3)

where,

ΔX: a variation of the touch position in X coordinates,

ΔY: a variation of the touch position in Y coordinates, and

ΔT: unit time

For example, the touch operation detecting unit 101, when detecting the touch-down of the operation finger by way of a touch on the touch panel 15a, starts up a timer function to measure the time, the timer function being equipped in the information processing apparatus 10. Further, the touch operation detecting unit 101, when detecting the touch-up implying a release of the operation finger kept so far touching the touch panel 15a, stops the timer function to measure the time, the timer function being started up when detecting the touch-up. The touch operation detecting unit 101 calculates the moving distance and the moving speed each related to the touch operation during a period from, e.g., the touch-down to the touch-up on the basis of the formulae (2) and (3). The moving distance and the moving speed each related to the touch operation are calculated on per unit time related to, e.g., the time measurement of the timer function. The unit time related to the time measurement can be exemplified by, e.g., the unit of nano second, the unit of micro second, the unit of millisecond, etc. Note that the unit time related to the time measurement may also be a count value counted in unit time such as the unit of microsecond.

The touch operation detecting unit 101 detects the variation of the touch position in the coordinates per unit time of the timer function, and calculates the moving distance and moving speed each related to the touch operation from the variation of the touch position in the coordinates with an elapse of time. The power control unit 102 is notified of the moving distance and the moving speed each related to the touch operation, which are calculated by the touch operation detecting unit 101, together with the touch position on a per unit time basis.

The power control unit 102 specifies the type of the touch operation accompanying the execution of the application from, e.g., the moving distance and the moving speed each related to the touch operation, which are calculated by the touch operation detecting unit 101. Then, the power control unit 102 selects and sets the governor table corresponding to the time-course variation of state quantity related to the touch operation per type of, e.g., the specified touch operation. The power control unit 102 switches over, e.g., the retained governor table corresponding to the time-course variation of state quantity per type of the touch operation, and thus performs the governor control pertaining to the power consumption etc. The governor control related to the touch operation is implemented continuously during the execution of the application. Note that the power control unit 102 may start up, e.g., the information processing apparatus 10, then may simultaneously deploy the governor table stored in the auxiliary storage unit 13 over a predetermined area of the main storage unit 12 and may retain the governor table. Moreover, the power control unit 102 may also, though the governor table is to be used, conduct the governor control by employing a mathematical expression for determining the operation frequency of the transition destination on condition that the operation frequency and the processing load during the operation are used.

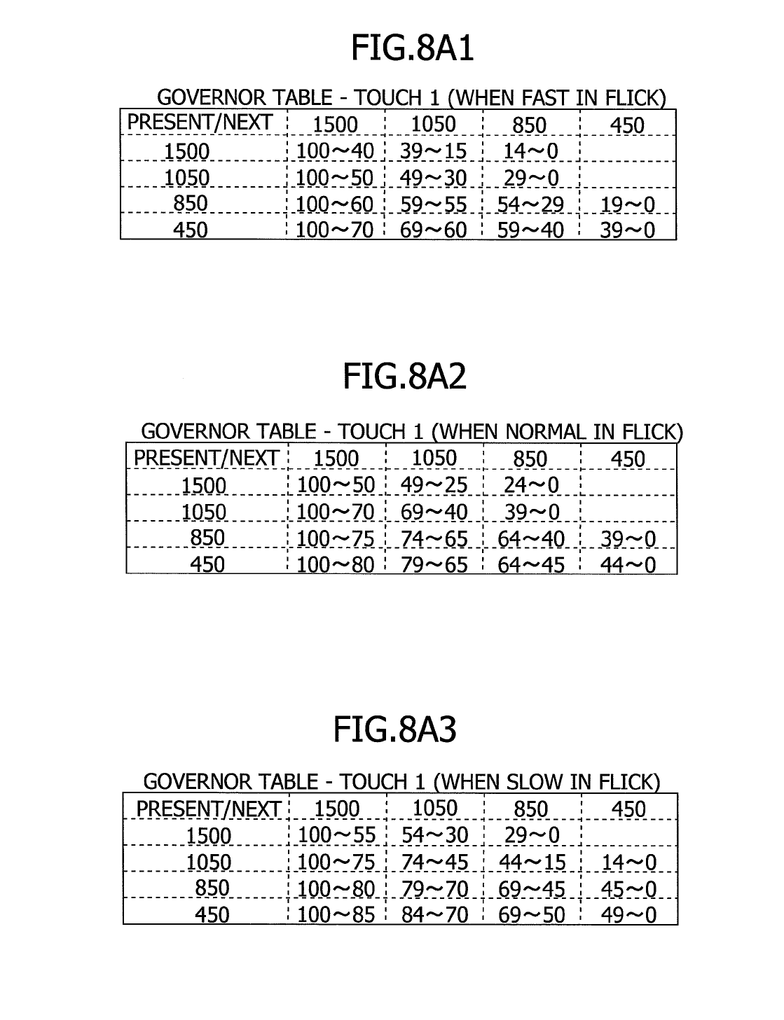

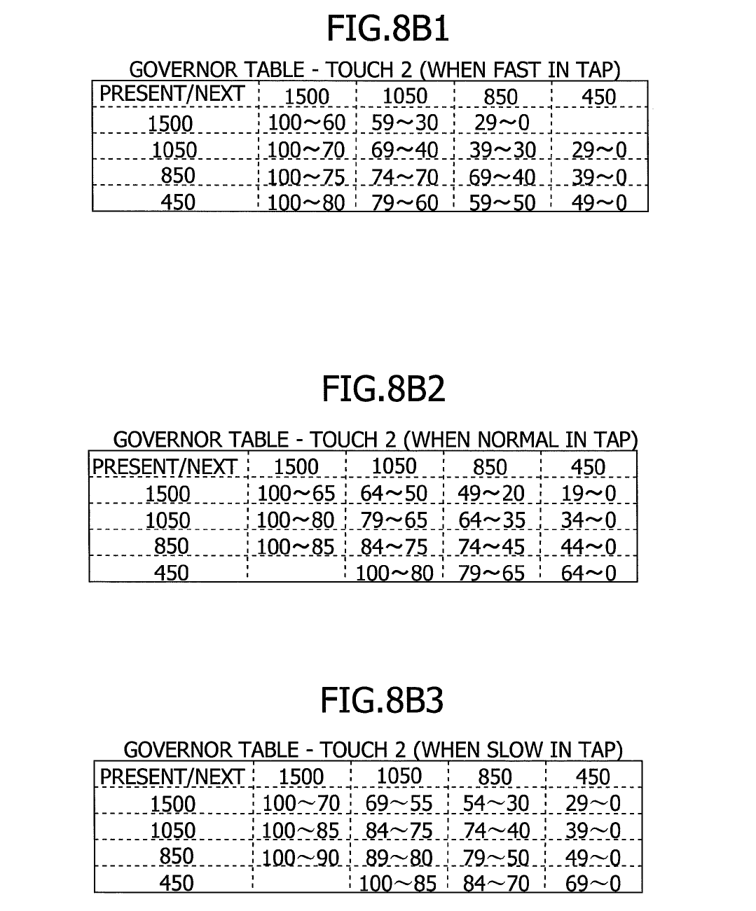

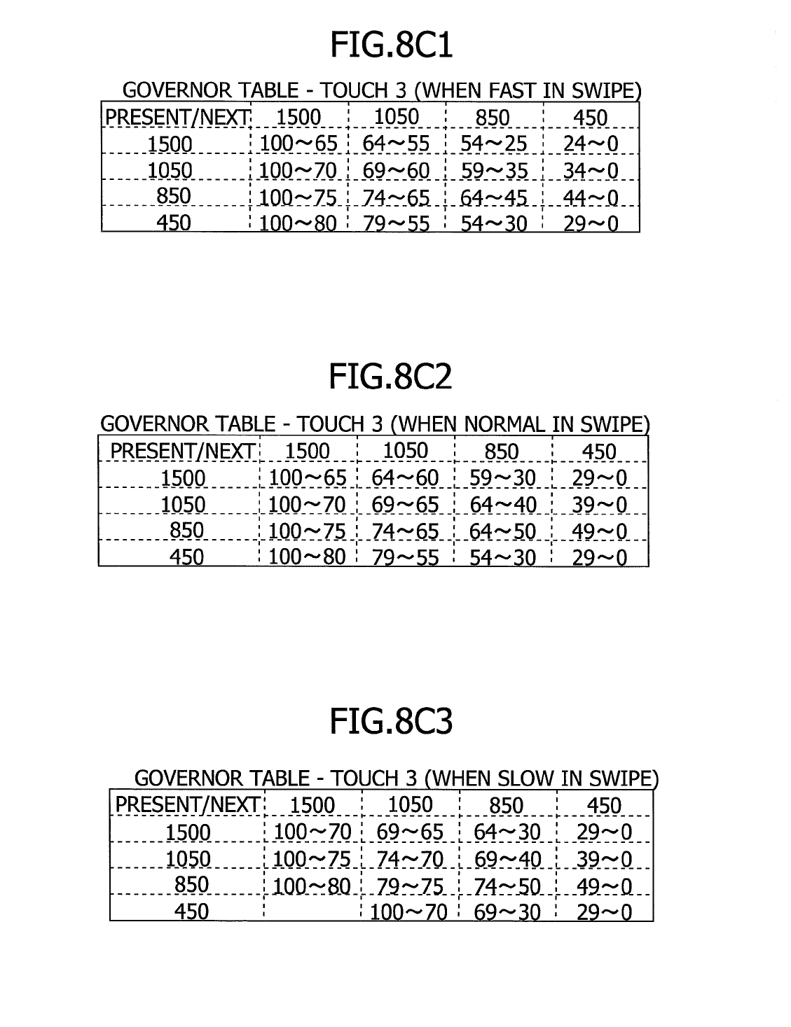

For example, the CPU clock control unit 10b is notified of the governor table selected by the power control unit 102. The CPU clock control unit 10b controls the clock frequency supplied to the peripheral circuits including the CPU on the basis of, e.g., the operation frequency in the selected governor table. An in-depth description of the power control unit 102 will be given later on in the discussion on processes in FIGS. 8-10.

Note that in the architecture of the information processing apparatus 10, the touch operation detecting unit 101 and the power control unit 102 may each function as API (Application Programming Interface) implemented on, e.g., a HAL (Hardware Abstraction Layer) etc. A response to the touch operation can be enhanced by making the touch operation detecting unit 101 and the power control unit 102 function as the API implemented on the HAL etc. Furthermore, in the architecture of the information processing apparatus 10, the touch operation detecting unit 101 and the power control unit 102 may be configured to include a function of, e.g., an application framework (Application Framework). The governor control executed in the information processing apparatus 10 can be managed more minutely corresponding to the processing load and the detected type etc. of the touch operation.

[Structure of Table]

FIGS. 8A-8C illustrate one example of the governor table related to the touch operation. FIG. 8A depict the examples of the governor tables related to the flick operation as the type of the touch operation. FIGS. 8B and 8C similarly illustrate examples of the governor tables related to the tap operation and the swipe operation, respectively. The vertical line of “present/next” column in each of the governor tables in FIGS. 8A-8C indicates, similarly to FIGS. 1C and 2C, the operation frequency of the information processing apparatus 10 executing the application underway. Further, the horizontal line of “present/next” column in each of the governor tables in FIGS. 8A-8C indicates, similarly to FIGS. 1C and 2C, the operation frequency of the information processing apparatus 10 transitioning, e.g., per detected type of the touch operation. In the examples of the governor tables in FIGS. 8A-8C, the operation frequency of the information processing apparatus is set at 4-stages such as “450” MHz, “850” MHz, “1050” MHz and “1500” MHz. In the examples of the governor tables in FIGS. 8A-8C, the state quantity of the processing load is set as the condition for the operation frequency to transition in the column at the intersection between the vertical line of the “present/next” column and the horizontal line of the “present/next” column.

(Flick Operation)

The governor table illustrated in FIG. 8A includes 3-stage governor tables illustrated in FIG. 8A1 through FIG. 8A3, in which the time-course variation of state quantity of the flick operation corresponds to high/low levels of the detected moving speed. In the examples of the governor tables in FIG. 8A, the moving speed of the flick operation decreases (gets slower) in the sequence of FIG. 8A1→FIG. 8A2→FIG. 8A3 depicted therein. Note that the high/low levels of the moving speed of the flick operation can be determined by providing, e.g., a plurality of threshold values.

For example, it may be sufficient that the power control unit 102 provide 2-stage threshold values having a relationship such as Thv1>Thv2 and determines the moving speed of the flick operation detected by the touch operation detecting unit 101. For instance, the power control unit 102 determines the detected moving speed to be “slow” if the detected moving speed TV has a relationship of TV<Thv2, and may select the governor table illustrated in FIG. 8A3. Similarly, the power control unit 102 determines the detected moving speed to be “normal” if the detected moving speed TV has a relationship of, e.g., Thv2≦TV<Thv1, and may select the governor table illustrated in FIG. 8A2. Furthermore, the power control unit 102 determines the detected moving speed to be “fast” if the detected moving speed TV has a relationship of Thv1≦TV, and may select the governor table illustrated in FIG. 8A1.

In the governor tables illustrated in FIG. 8A, the condition for the operation frequency to transition varies corresponding to the time-course variation of state quantity of the flick operation. In the governor tables of FIGS. 8A1-8A3, upper and lower limit values of the range of CPU operating ratio defined as the state quantity of the processing load for the operation frequency to transition, vary corresponding to the detected moving speeds. For example, in the governor table of FIG. 8A1, a range of CPU operating ratio of “39-0”% is set for “450” MHz after transitioning from the operation frequency of “450” Mhz. Under the same condition of the operation frequency, a range of CPU operating ratio of “44-0”% is set for “450” MHz in the governor table of FIG. 8A2, and a range of CPU operating ratio of “49-0”% is set for “450” MHz in the governor table of FIG. 8A3. Namely, if the detected moving speed of the flick operation is slow, the transition of the operation frequency is restrained by increasing the upper limit value of the CPU operating ratio, thereby restraining the power consumption accompanying the operation at the high clock frequency. Whereas if the detected moving speed of the flick operation is fast, the transition of the operation frequency is accelerated by decreasing the upper limit value of the CPU operating ratio, thereby ensuring the performance with respect to the processing load.

In each of the governor tables related to the flick operation illustrated in FIG. 8A, for instance, the state quantities of the processing load as the transitional conditions with respect to the 4-stage operation frequencies described above are set in a row associated with “450” Mhz in the vertical line of the “present/next” column.

For example, in the governor table illustrated in FIG. 8A1, a range of CPU operating ratio of “100-70”% is set for “1500” MHz after transitioning from the operation frequency of “450” Mhz. Similarly, a range of CPU operating ratio of “69-60”% is set for “1050” MHz as the post-transition operation frequency; a range of CPU operating ratio of “59-40”% is set for “850” MHz; and a range of CPU operating ratio of “39-0”% is set for “450” MHz. Therefore, in the example of the governor table in FIG. 8A1, for instance, the operation frequency of “1500” Mhz associated with the CPU operating ratio of 100% can be set with respect to the CPU operating ratio reaching 100% at the timing t2 in the example of FIG. 1A. The same is applied to the examples of the governor tables in FIGS. 8A2 and 8A3, and the operation frequency for ensuring the performance corresponding to the variation of the processing load accompanying the flick operation can be set in the governor table related to the flick operation depicted in FIG. 8A. For example, it is feasible to restrain the frequency difference between the operation frequency for ensuring the performance and the operation frequency set for the processing load, the frequency difference occurring in the governor table set in the power emphasized type in FIG. 1C.

Further, in each of the governor tables related to the flick operation illustrated in FIG. 8A, the state quantity of the processing load as the transitional condition for “450” MHz in the 4-stage operation frequencies is not set in the row associated with “1500” Mhz in the vertical line of “present/next” column. In each of the governor tables related to the flick operation illustrated in FIG. 8A, the operation frequency being transition-enabled from the operation frequency of “1500” Mhz stops decreasing down to “850” MHz. Then, for instance, if the moving speed of the flick operation in FIG. 8A1 is “fast”, a range of CPU operating ratio of “100-40”% is set for the operation frequency of “1500” MHz of the transitioning destination from the operation frequency of “1500” Mhz. Similarly, a range of CPU operating ratio of “100-50”% is set if the moving speed of the flick operation in FIG. 8A2 is “normal”, and a range of CPU operating ratio of “100-55”% is set if the moving speed of the flick operation in FIG. 8A3 is “slow”. A range width of the CPU operating ratio for the post-transition operation frequency of “1500” MHz is 60% in FIG. 8A1, 50% in FIG. 8A2 and 45% in FIG. 8A3.

Thus, in the governor table of FIG. 8A, it follows that the performance for the variation of the processing load accompanying the flick operation is kept by expanding the range width of the CPU operating ratio as the transitional condition with respect to the highest operation frequency. Further, the operation frequency being transition-enabled from the operation frequency of “1500” Mhz stops decreasing down to “850” MHz. Hence, e.g., as illustrated in FIG. 3C, the performance for continuing the scroll process is kept also in the scroll process continued after the operation finger 90 has released from the touch panel 15a.

Note that in each of the examples of the governor tables in FIGS. 8A1 and 8A2, the state quantity of the processing load as the transitional condition for the operation frequency of “450” MHz is not set in the row associated with “1050” Mhz in the vertical line of “present/next” column. In each of the examples of the governor tables in FIGS. 8A1 and 8A2, the operation frequency being transition-enabled from the operation frequency of “1050” Mhz stops decreasing down to “850” MHz. Therefore, if the detected moving speed of the flick operation is equal to or greater than a predetermined value (e.g., the threshold value Thv1) and even when the operation frequency in the operation underway is not the highest operation frequency, it is possible to keep the performance corresponding to the variation of the processing load accompanying the flick operation.

(Tap Operation)

The governor table illustrated in FIG. 8B for the tap operation includes, similarly to FIG. 8A, 3-stage governor tables illustrated in FIG. 8B1 through FIG. 8B3, which correspond to the time-course variations of state quantity of the tap operation. The time-course variation of state quantity when performing the tap operation can be exemplified by a long/short interval between one tap operation and another tap operation that are continuously performed. For example, a game application involving the frequent use of the tap operations is demanded of responsibility to a game scene displayed on the touch panel. In the game scene demanded of readiness, the tap-to-tap interval is comparatively short, and a time-course variation of screen of the game scene displayed on the touch panel become much faster corresponding to the short tap-to-tap interval, resulting in a tendency exhibiting a higher processing load. In the example of the governor table of FIG. 8B, the tap-to-tap interval becomes longer in the sequence as indicated by FIG. 8B1→FIG. 8B2→FIG. 8B3. Note that a short or long tap-to-tap interval can be determined by providing, e.g., a plurality of threshold values.

For instance, as illustrated in FIG. 5B, the touch position of the operation finger when performing the tap operation does not substantially move during the touching period, and the moving speed is substantially “0”. For example, the power control unit 102 provides a threshold value Thr1 for the moving distance TR, notified from the touch operation detecting unit 101, of the touch operation, and may determine whether the tap-to-tap interval is long or short when TR<Thr1. Note that the power control unit 102 may determine the type of touch such as whether the touch operation is the flick operation or the swipe operation when TR≧Thr1. Moreover, for instance, the power control unit 102 provides a threshold value for Thr3<Thv2, and may determine whether the tap-to-tap interval is long or short when the detected moving speed TV is given by TV<Thv3. In this case, the power control unit 102 may determine the type of touch such as whether the touch operation is the flick operation or the swipe operation when TV≧Thv3.

The power control unit 102, e.g., when satisfying a magnitude relationship between the moving distance TR and the threshold value Thr1 or a magnitude relationship between the moving speed TV and the threshold value Thv3 as described above, starts up the timer function after the touch-up. Then, the power control unit 102, when detecting such a time-series continuous touch operation that the moving distance TR or the moving speed TV again satisfies the relationship described above after starting up the timer, may acquire measurement time (Tint) counted from after starting up the timer. Subsequently, the power control unit 102 may determine whether the tap-to-tap interval detected by the touch operation detecting unit 101 is long or short, from the acquired measurement time (Tint) and 2-stage threshold values taking a relationship given by Tht1<Tht2. Note that the time measurement of the started timer function may be stopped when detecting the touch operation not satisfying the relationship described above after starting up the timer.

In the example of FIG. 8B, for instance, the power control unit 102, when the acquired measurement time (Tint) is expressed by Tht2<Tint, determines that the acquired tap-to-tap interval is “long”, and may select the governor table specified by “when slow in tap” illustrated in FIG. 8B3. Similarly, e.g., the power control unit 102, when the acquired measurement time (Tint) is expressed by Tht1<(Tint)≦Tht2, determines that the acquired tap-to-tap interval is “normal”, and may select the governor table specified by “when normal in tap” illustrated in FIG. 8B2. Moreover, for instance, the power control unit 102, when the acquired measurement time (Tint) is expressed by Tht1≧(Tint), determines that the acquired tap-to-tap interval is “short”, and may select the governor table specified by “when fast in tap” illustrated in FIG. 8B1.

In the governor tables illustrated in FIG. 8B, similarly to FIG. 8A, the condition for the operation frequency to transition varies corresponding to the time-course variation of state quantity of the tap operation. In the governor tables of FIGS. 8B1-8B3, the upper and lower limit values of the range of CPU operating ratio defined as the state quantity of the processing load for the operation frequency to transition, vary corresponding to whether the acquired measurement time (Tint) is long or short. For example, in the governor table specified by “when fast in tap” in FIG. 8B1, a range of CPU operating ratio of “49-0”% is set for “450” MHz after transitioning from the operation frequency of “450” Mhz. Under the same condition of the operation frequency, a range of CPU operating ratio of “64-0”% is set for “450” MHz in the governor table specified by “when normal in tap” in FIG. 8B2, and a range of CPU operating ratio of “69-0”% is set for “450” MHz in the governor table specified by “when the tap is slow” in FIG. 8B3. Namely, if the tap-to-tap interval is long, the transition of the operation frequency is restrained by increasing the upper limit value of the CPU operating ratio, thereby restraining the operation frequency from transitioning and also restraining the power consumption accompanying the operation at the high clock frequency. Whereas if the tap-to-tap interval is short, the transition of the operation frequency is accelerated by decreasing the upper limit value of the CPU operating ratio, thereby ensuring the performance with respect to the processing load.

Moreover, in the governor tables specified by “when normal in tap” in FIG. 8B2 and “when slow in tap” in FIG. 8B3, the range of CPU operating ratio is not set for “1500” MHz after transitioning from the operation frequency of “450” Mhz. In the examples of the governor tables of the tap operation determined such as “when normal in tap” and “when slow in tap”, the operation frequency being transition-enabled from the operation frequency of “450” Mhz stops increasing up to “1050” MHz. Therefore, in the examples of the governor tables of the tap operation determined such as “when normal in tap” and “when slow in tap”, it does not happen that the operation frequency transitions steeply up to the highest operation frequency in relation to the rise in processing load. For example, like the governor control set in the performance emphasized type as illustrated in FIG. 2B, even if the allowance is still left such as when the CPU operating ratio is 60%, the operation frequency does not transition to “1500” MHz exhibiting the highest performance. In each of the examples of the governor tables of FIGS. 82 and 83, the operation frequency of “450” MHz is kept, and hence it is possible to improve the effect in restraining the power consumption.

Further, in the examples of the governor tables specified by “when normal in tap” in FIG. 8B2 and “when slow in tap” in FIG. 8B3, the CPU operating ratios are set for the 4-stage operation frequencies being transition-enabled from the operation frequencies of “1500” Mhz and “1050” MHz. Hence, in the examples of the governor tables of FIGS. 8B2 and 8B3, the operation frequency can be set in a way that follows a decreasing variation of the processing load. In the examples of the governor tables of FIGS. 8B2 and 8B3, it is possible to restrain the frequency difference occurring between the operation frequency for ensuring the performance and the operation frequency set corresponding to the processing load. For example, like the governor control set in the performance emphasized type as depicted in FIG. 2B, there is a less possibility of decreasing the effect in restraining the power consumption due to the operation at an excessively high clock frequency because of setting the operation frequency high for the processing load.

Note that in the example of the governor table specified by “when fast in tap” in FIG. 8B1, the range of CPU operating ratio is not set for “450” MHz after transitioning from the operation frequency of “1500” Mhz. This is because of ensuring the performance for the variations of the processing loads of the continuously occurring tap operations. Note that in the example of the governor table specified by “when fast in tap” in FIG. 8B1 also, the CPU operating ratio is set for the 4-stage operation frequencies being transition-enabled from the operation frequencies of “1050” MHz. Accordingly, in the information processing apparatus being operated at “1500” Mhz in FIG. 81, when the CPU operating ratio is “0”%, the operation frequency transitions to “850” MHz, and, if keeping the CPU operating ratio at “0”% after the transition also, the operation frequency can transition to “450” MHz. Even “when fast in tap” in FIG. 8B1, it is feasible to minimize the frequency difference occurring between the operation frequency for ensuring the performance and the operation frequency set corresponding to the processing load.

(Swipe Operation)

The governor table illustrated in FIG. 8C for the swipe operation includes, similarly to FIG. 8A, 3-stage governor tables illustrated in FIG. 8C1 through FIG. 8C3, which correspond to the time-course variations of state quantity of the swipe operation. The time-course variation of state quantity when performing the swipe operation can be exemplified, similarly to the flick operation, by the high/low (fast/slow) moving speed of the swipe operation. It is feasible to determine whether the moving speed of the swipe operation is high or low by providing the plurality of threshold values as in the case of the flick operation. Note that in the example of the governor table of FIG. 8C, the moving speed of the swipe operation becomes slower in the sequence as indicated by FIG. 8C1→FIG. 8C2→FIG. 8C3.

As illustrated in FIG. 5C, the swipe operation is that the operation finger stops moving in the display position of the moving destination, whereby the moving speed just before the touch-up has a decelerating tendency, and the moving speed when performing the touch-up becomes substantially “0”. For example, the power control unit 102 may, when determining the moving speed related to the swipe operation, determine the moving speed when performing the touch-up. The determination of the moving speed related to the swipe operation is the same as in the case of the flick operation in FIG. 8A.

For example, the power control unit 102 provides a third threshold value taking a relationship of Thv2>Thv3, and may, when the detected moving speed TV is expressed by Thv3≦TV, make the determination using the threshold values Thv1 and Thv2 explained in FIG. 8A. Then, after making the determination using the threshold values Thv1 and Thv2, such a status may be detected that the moving speed when performing the touch-up becomes Thv3>TV by continuously monitoring the moving speed TV related to the touch operation.

For instance, the power control unit 102, when the detected moving speed TV satisfies a relationship of Thv3≦TV and when TV<Thv2, determines that the detected moving speed is “slow”, and continuously monitors the moving speed TV related to the touch operation. Then, the power control unit 102, when the moving speed TV when performing the touch-up is expressed by TV<Thv3, may select the governor table specified by “when slow in swipe” illustrated in FIG. 8C3. Similarly, the power control unit 102, when the detected moving speed TV satisfies the relationship of Thv3≦TV and when Thv2≦TV<Thv1, determines that the detected moving speed is “normal”, and continuously monitors the moving speed TV related to the touch operation. Then, the power control unit 102, when the moving speed TV when performing the touch-up is expressed by TV<Thv3, may select the governor table specified by “when normal in swipe” illustrated in FIG. 8C2. Still further, for instance, the power control unit 102, when the detected moving speed TV satisfies the relationship of Thv3≦TV and when Thv1≦TV<Thv1, determines that the detected moving speed is “fast”, and continuously monitors the moving speed TV related to the touch operation. Then, the power control unit 102, when the moving speed TV when performing the touch-up is expressed by TV<Thv3, may select the governor table specified by “when fast in swipe” illustrated in FIG. 8C1.

In the governor table illustrated in FIG. 8C also, similarly to FIG. 8A, the condition for the operation frequency to transition varies corresponding to the time-course variation of state quantity of the swipe operation. In the governor tables of FIGS. 8C1-8C3, the upper and lower limit values of the range of CPU operating ratio defined as the state quantity of the processing load for the operation frequency to transition, vary corresponding to whether the detected moving speed is high or low (fast/slow).

For instance, in the examples of the governor tables specified by “when fast in swipe” in FIG. 8C1 and “when normal in swipe” in FIG. 8C2, the range of CPU operating ratio is set for 4-stage operation frequencies being transition-enabled from the operation frequency of “450” Mhz. However, in the example of the governor table specified by “when slow in swipe” in FIG. 8C3, the range of CPU operating ratio is not set for “1500” MHz after transitioning from the operation frequency of “450” Mhz. In the example of the governor table for the swipe operation determined such as “when slow in swipe”, the operation frequency being transition-enabled from the operation frequency of “450” Mhz stops increasing up to “1050” MHz. In the swipe operation determined such as “when slow in swipe”, it does not happen that the operation frequency transitions steeply up to the operation frequency of “1500” MHz exhibiting the highest performance. Therefore, in the example of the governor table in FIG. 8C3, it is feasible to restrain the rise in power consumption due to the operation at the excessively high clock frequency when performing the swipe operation. On the other hand, in FIGS. 8C1 and 8C2, the operation frequency can transition steeply up to the operation frequency of “1500” MHz exhibiting the highest performance from the operation frequency of “450” Mhz. It is therefore possible to ensure the performance for the increase in processing load in the examples of the governor tables in FIGS. 8C1 and 8C2.

Moreover, in the respective governor tables for the swipe operation illustrated in FIG. 8C, the CPU operating ratios stored in the row associated with the “1500” columns in the horizontal lines of the “present/next” column of “when fast in swipe operation” are common to the CPU operating ratios of “when normal in swipe operation”. In the examples of the governor tables in FIG. 8C, the performance for the rise in processing load when starting the swipe operation is ensured by commonizing the CPU operating ratios stored in the rows associated with the “1500” columns in the horizontal lines of the “present/next” columns.

Then, in the respective governor tables for the swipe operation illustrated in FIG. 8C, the CPU operating ratios stored in the row associated with the “450” columns in the horizontal lines of the “present/next” column of “when normal in swipe operation” are common to the CPU operating ratios of “when slow in swipe”. In the examples of the governor tables in FIG. 8C, the power consumption for the decrease in processing load when stopping the swipe operation is restrained by commonizing the CPU operating ratios stored in the rows associated with the “450” columns in the horizontal lines of the “present/next” columns.

For example, in the examples of the governor tables in FIGS. 8C2 and 8C3, the CPU operating ratio for the “450” MHz after transitioning from the operation frequency of “850” Mhz has a common range of “49-0”%. Hence, in the examples of the governor tables for the swipe operation in FIG. 8C, it is feasible to transition to the same operation frequency if within the predetermined range of CPU operating ratio without depending on the detected moving speed. For example, in the case of “when normal in swipe”, it is possible to restrain the power consumption for the decrease in processing load when stopping the swipe operation. Further, similarly, in the examples of the governor tables in FIGS. 8C1 and 8C2, the CPU operating ratio for the “1500” MHz after transitioning from the operation frequency of “850” Mhz has a common range of “100-75”%. Therefore, in the examples of the governor tables for the swipe operation in FIG. 8C, it is feasible to transition to the same operation frequency if within the predetermined range of CPU operating ratio without depending on the detected moving speed. For example, in the case of “when normal in swipe”, it is possible to ensure the performance for the increase in processing load when starting the swipe operation.

[Processing Flow]

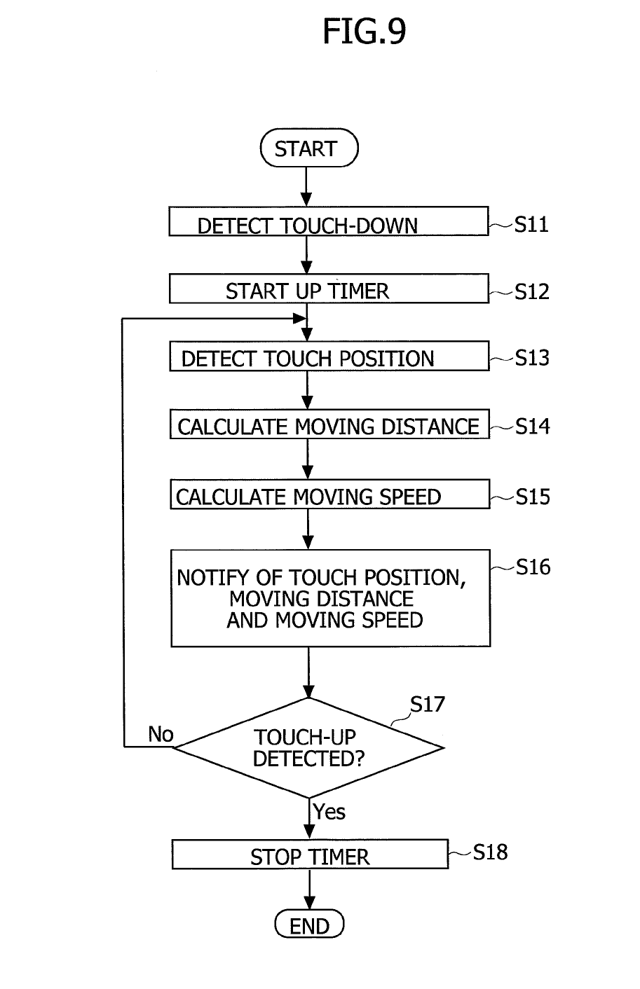

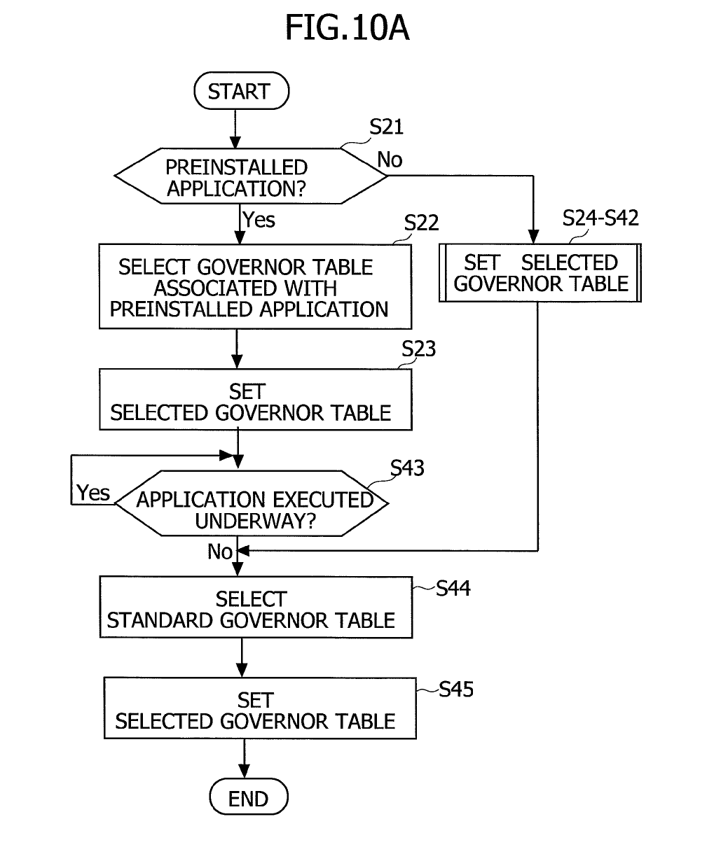

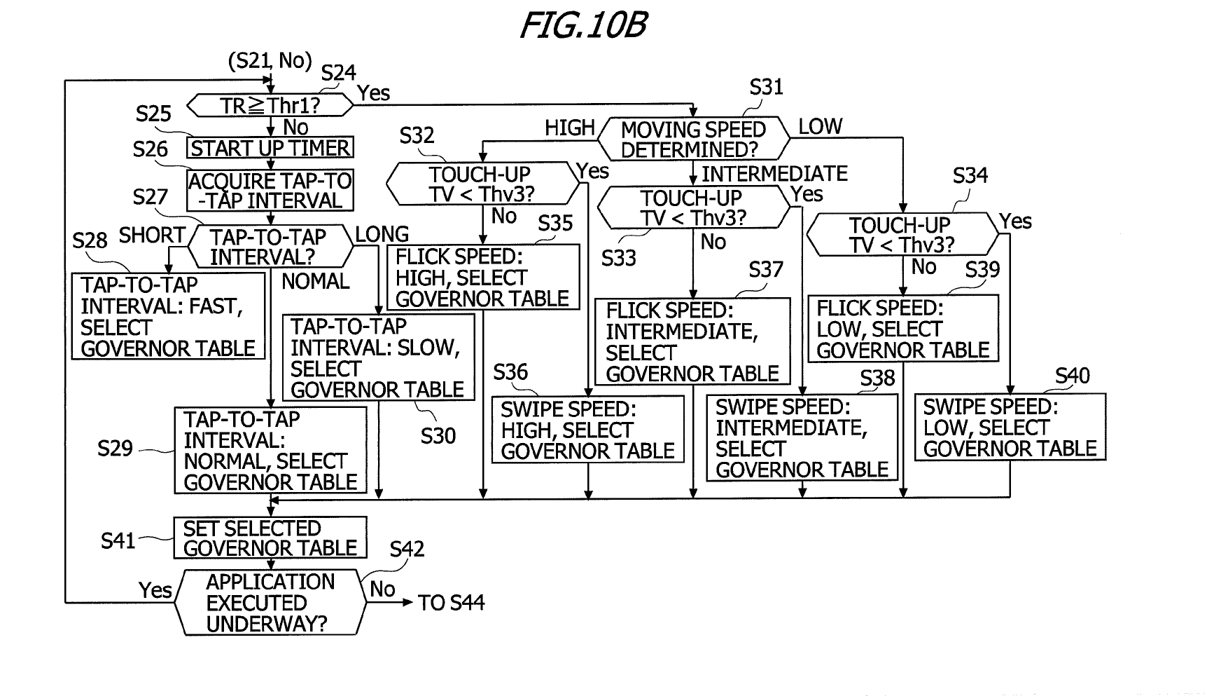

Processes related to the governor control of the information processing apparatus 10 according to the embodiment will hereinafter be described with reference to FIGS. 9 and 10. FIG. 9 is a flowchart of a touch detecting process of the information processing apparatus 10.

(Touch Detecting Process)

In the flowchart of FIG. 9, a start of the touch detecting process can be exemplified when executing the application. The information processing apparatus 10 detects the touch-down onto the touch panel 15a and starts up the timer function (S11-S12). Then, the information processing apparatus 10 detects the touch position per unit time related to the time measurement of the timer function, and calculates the moving distance and the moving speed (S13-S15). For example, the power control unit 102 is notified of the detected touch position, the calculated moving distance and the calculated moving speed (S16). The processes in S13-S16 are iterated till detecting the touch-up (S17, No—S13).

Subsequently, the information processing apparatus 10, when detecting the touch-up (S17, Yes), stops the timer function started up in S12 (S18), and finishes the touch detecting process. The information processing apparatus 10 executes a governor control process depicted in FIG. 10 on the basis of the touch position detected in the touch detecting process, the moving distance and the moving speed.

Herein, the processes in S11-S18 executed by the information processing apparatus 10 are one example of a first acquiring a type and an operation speed of the touch operation on an instruction field on a detection surface. Further, the CPU 11 etc. of the information processing apparatus 10 executes the processes in S11-S18 by way of one example of the first acquiring the type and the operation speed of the touch operation on the instruction field on the detection surface.

(Switchover Process of Governor Table)

FIGS. 10A and 10B illustrate flowcharts of the switchover process of the governor table when the information processing apparatus 10 executes the application. Under the governor control according to the embodiment, for instance, the information processing apparatus 10 selects and sets the governor table corresponding to the time-course variation of state quantity related to the touch operation per type of the touch operation. The information processing apparatus 10 according to the embodiment switches over and sets the governor table selected corresponding to the type of the touch operation, thereby implementing the governor control suited to the execution of the application. Note that the discussion on the flowcharts of FIGS. 10A and 10B is made on the assumption that the governor table set per type of the touch operation is retained in a predetermined area of, e.g., the main storage unit 12. For example, the information processing apparatus 10 may read, upon a startup of the information processing apparatus 10, the governor table corresponding to the variation of the status per type of the touch operation that is stored in the auxiliary storage unit 13, and may deploy the readout governor table in the predetermined area of the main storage unit 12. Furthermore, in an initial status such as power-on of the information processing apparatus 10, for instance, the description is made on the assumption that there is set the standard governor table of the power emphasized type illustrated in FIG. 1C or the performance emphasized type depicted in FIG. 2C.

In the flowchart illustrated in FIG. 10A, a start of the switchover process of the governor table can be exemplified when receiving application startup notification issued by the launcher application 10a illustrated in FIG. 7. For example, the information processing apparatus 10 determines from an application name etc. being startup-notified from the launcher application 10a whether the started application is a preinstalled application or an unknown application (S21). The information processing apparatus 10 refers to, e.g., a table etc. containing the application name etc. of the preinstalled application, and determines whether the started application is the preinstalled application or the unknown application. Note that such a table may be stored beforehand in, e.g., the auxiliary storage unit 13, may be read together with the startup of the information processing apparatus 10 and may be deployed in the predetermined area of the main storage unit 12.

The information processing apparatus 10, if the started application is the preinstalled application (S21, Yes), selects the governor table corresponding to the preinstalled application (S22). Then, the information processing apparatus 10 sets the governor table selected in the process in S22 (S23) and moves to a process in S43. In the process in S43, the information processing apparatus 10 determines whether the application as a target application of the switchover process of the governor table is executed underway or not. The information processing apparatus 10, if the application is not executed underway (S43, No), selects and sets the standard governor table of the power emphasized type or the performance emphasized type (S44-S45), and terminates the switchover process of the governor table. Whereas if the application is executed underway (S43, Yes), the information processing apparatus 10 waits for termination of the application. Note that the termination of the application can be determined from, e.g., termination notification given from the launcher application 10a.

The information processing apparatus 10 may previously retain the governor table corresponding to the preinstalled application in the predetermined area of the main storage unit 12. For example, the information processing apparatus 10 may read, upon the startup, the governor table corresponding to the preinstalled application stored in the auxiliary storage unit 13, and may deploy this table in the predetermined area of the main storage unit 12. The information processing apparatus 10 controls the drive voltage on the basis of the CPU operating ratio in the governor table corresponding to the preinstalled application set in the process, e.g., in S23, and gets the operation frequency during the operation to transition corresponding to the variation of the state quantity of the processing load.

Whereas if the started application is not the preinstalled application (S21, No), the information processing apparatus 10 moves to a process in S24 and determines the type of the touch operation accompanying the execution of the application. Then, the information processing apparatus 10 selects and sets the governor table corresponding to the time-course variation of state quantity related to the touch operation per type of the touch operation in the processes in S24-S42.

In the process in S24 of the flowchart illustrated in FIG. 10B, the information processing apparatus 10 determines the type of the touch operation from the time-course variation of state quantity such as the moving distance TR and the moving speed TV accompanying the touch operation. For instance, the information processing apparatus 10 determines, from the magnitude relationship between the moving distance TR and the threshold value Thr1 or between the moving speed TV and the threshold value Thv3, whether the touch operation accompanying the execution of the application is the tap operation or not. The information processing apparatus 10, e.g., if the magnitude relationship between the moving distance TR and the threshold value Thr1 satisfies Thr1≦TR, determines that the touch operation is not the tap operation (S24, Yes). Whereas if the magnitude relationship between the moving distance TR and the threshold value Thr1 does not satisfies Thr1≦TR, the information processing apparatus 10 determines that the touch operation is the tap operation (S24, No). Note that in the process in S24 the determination as to whether the touch operation accompanying the execution of the application is the tap operation or not, is made based on the magnitude relationship between the moving distance TR and the threshold value Thr1, however, the determination may be made based on the magnitude relationship between the moving speed TV and the threshold value Thv3. For example, the information processing apparatus 10, if the magnitude relationship between the moving speed TV and the threshold value Thv3 satisfies Thv3≦TV, determines that the touch operation is not the tap operation (S24, Yes) and may, whereas if not, determine that the touch operation is the tap operation (S24, No).

The information processing apparatus 10 starts up the timer when determining in the process in S24 that the touch operation is the tap operation, and acquires the tap-to-tap interval of the continuously-performed tap operations (S25-S26). Then, the information processing apparatus 10 determines, from the tap-to-tap interval acquired in the process in S26, that the tap-to-tap interval has 3-stage long/short intervals (S27). Note that the acquisition of the tap-to-tap interval and the determination as to whether the tap-to-tap interval is long or short, have been described in FIG. 8B.

The information processing apparatus 10, e.g., if the tap-to-tap interval (Tint) acquired in the process in S26 is expressed by Tht2<Tint with respect to 2-stage threshold values taking a relationship of Tht1<Tht2, determines that the tap-to-tap interval is “long” (S27, interval=long). Then, the information processing apparatus 10 selects the governor table specified by “when slow in tap” illustrated in, e.g., FIG. 8B3 (S30). Similarly, the information processing apparatus 10 determines that the acquired tap-to-tap interval is “normal” (S27, interval=normal) if the tap-to-tap interval (Tint) is expressed by Tht1<(Tint)≦Tht2, and selects, e.g., the governor table specified by “when normal in tap” illustrated in FIG. 8B2 (S29). Moreover, the information processing apparatus 10 determines that the acquired tap-to-tap interval is “short” (S27, interval=short) if the tap-to-tap interval (Tint) is expressed by Tht1≧(Tint), and selects, e.g., the governor table specified by “when fast in tap” illustrated in FIG. 8B1 (S28).

Note that in the process in S27, the information processing apparatus 10 determines the time-course variation of state quantity related to the tap operation at the 3 stages and selects the governor table corresponding to each state, however, the determination is not limited to the 3 stages. For example, the information processing apparatus 10 may make the determination in 5-stage states and may also make the determination in 2-stage states. For instance, the information processing apparatus 10 may determine the time-course variation of state quantity related to the tap operation at multi-stages in accordance with the circuit configuration, the throughput, etc. of the CPU and suchlike. It is feasible to conduct the governor control suited to the circuit configuration, the throughput, etc. of the CPU and suchlike of the information processing apparatus 10.

The information processing apparatus 10 sets the governor table corresponding to the long or short tap-to-tap interval as the time-course variation of state quantity related to the tap operation, the governor table being selected in the processes in S28-S30, as the table used for performing the governor control (S41), and moves to a process in S42.

To get back to the process in S24, the information processing apparatus 10, when determining that the touch operation is not the tap operation, determines whether the moving speed accompanying the touch operation as the time-course variation of state quantity is high or low (fast/slow) at 3 stages (S31). Note that the determination as to whether the moving speed accompanying the touch operation is high or low (fast/slow) has been described in FIGS. 8A and 8C.

The information processing apparatus 10, e.g., if the moving speed TV accompanying the touch operation is expressed by TV<Thv2 with respect to the 2-stage threshold values taking a relationship of Thv1>Thv2, determines that the moving speed TV accompanying the touch operation is “slow” (S31, speed=low), and moves to S33. Similarly, the information processing apparatus 10, if the moving speed TV accompanying the touch operation is expressed by Thv2≦TV<Thv1, determines that the moving speed TV accompanying the touch operation is “normal” (S31, speed=intermediate), and moves to S33. Furthermore, the information processing apparatus 10, if the moving speed TV accompanying the touch operation is expressed by Thv1≦TV, determines that the moving speed TV accompanying the touch operation is “fast” (S31, speed=fast), and moves to S32.

In the process in S32, the information processing apparatus 10 determines the moving speed TV given when performing the touch-up of the touch operation determined to be, e.g., “fast” in the process in S31. As described in FIGS. 8A and 8C, the moving speed given when performing the touch-up of the swipe operation is substantially “0”, while the moving speed is not decelerated when performing the touch-up of the flick operation, and hence it does not happen that the moving speed becomes substantially “0”. Therefore, in the process in S32, the information processing apparatus 10 determines, e.g., that the relationship between the moving speed TV given when performing the touch-up and the threshold value Thv3 is expressed by TV<Thv3. The information processing apparatus 10, if the moving speed TV given when performing the touch-up is equal to or higher than Thv3, determines that the touch operation is the flick operation (S32, No). Whereas if the moving speed TV given when performing the touch-up is less than Thv3, the information processing apparatus 10 determines that the touch operation is the swipe operation (S32, Yes). It is to be noted that the execution of the same determination process is applied to the processes in S33 and S34.

The information processing apparatus 10, when determining in the process in S32 that the touch operation is the flick operation (S32, No), selects the governor table specified by “when fast in flick” illustrated in FIG. 8A1 (S35). On the other hand, the information processing apparatus 10, when determining in the process in S32 that the touch operation is the swipe operation (S32, Yes), selects, e.g., the governor table specified by “when fast in swipe” illustrated in FIG. 8C1 (S36).

Similarly, the information processing apparatus 10, when determining in the process in S33 that the touch operation is the flick operation (S33, No), selects the governor table specified by “when normal in flick” illustrated in FIG. 8A2 (S37). On the other hand, the information processing apparatus 10, when determining in the process in S33 that the touch operation is the swipe operation (S33, Yes), selects, e.g., the governor table specified by “when normal in swipe” illustrated in FIG. 8C2 (S38).

Moreover, the information processing apparatus 10, when determining in the process in S34 that the touch operation is the flick operation (S34, No), selects the governor table specified by “when slow in flick” illustrated in FIG. 8A3 (S39). On the other hand, the information processing apparatus 10, when determining in the process in S34 that the touch operation is the swipe operation (S34, Yes), selects, e.g., the governor table specified by “when slow in swipe” illustrated in FIG. 8C3 (S40).

In the process in S31, the information processing apparatus 10 determines the time-course variation of state quantity related to the touch operation at the 3 stages, however, the determination is not limited to the 3 stages. For example, the information processing apparatus 10 may make the determination in the 5-stage states and may also make the determination in the 2-stage states. For instance, the information processing apparatus 10 may determine the time-course variation of state quantity related to the touch operation at the multi-stages in accordance with the circuit configuration, the throughput, etc. of the CPU and suchlike. It is possible to conduct the governor control suited to the circuit configuration, the throughput, etc. of the CPU and suchlike of the information processing apparatus 10.

Further, in the process in S31, the information processing apparatus 10 uses the threshold values Thv1 and Thv2 common to the determinations of the flick operation and the swipe operation, however, a threshold value used for determining the moving speed TV may be provided per type of each operation. For example, the information processing apparatus 10 provides the threshold values used for determining the moving speed TV respectively to the flick operation and the swipe operation, thereby enabling the minuter governor control to be realized.

The information processing apparatus 10 sets the governor table corresponding to the high or low moving speed (fast/slow) as the time-course variation of state quantity related to the flick operation, the governor table being selected in the processes in S35, S37 and S39, as the table used for implementing the governor control (S41), and moves to a process in S42. Similarly, the information processing apparatus 10 sets the governor table corresponding to the high or low moving speed (fast/slow) as the time-course variation of state quantity related to the swipe operation, the governor table being selected in the processes in S36, S38 and S40, as the table used for implementing the governor control (S41), and moves to the process in S42.

In the process in S42, the information processing apparatus 10 determines whether the application as the target application of the switchover process of the governor table is executed underway or not. The information processing apparatus 10, if the application is not executed underway (S42, No), selects and sets the standard governor table of the power emphasized type or the performance emphasized type (S44-S45), and terminates the switchover process of the governor table. Whereas if the application is executed underway (S42, Yes), the information processing apparatus 10 loops back to the process in S24 and repeats the processes in S24-S42.

Herein, the processes in S28-S30 and S35-S40 executed by the information processing apparatus 10 are one example of setting an operating capability of the apparatus in accordance with the type of the touch operation and the load ratio of the apparatus. Further, the CPU etc. of the information processing apparatus 10 executes the processes in S11-S18 by way of one example of setting the operating capability of the apparatus in accordance with the type of the touch operation and the load ratio of the apparatus.

Moreover, the processes in S27 and S32-S34 executed by the information processing apparatus 10 are one example of setting the operating capability of the apparatus in accordance with the type of the touch operation and the load ratio of the apparatus. Further, the CPU etc. of the information processing apparatus 10 executes the processes in S27 and S32-S34 by way of one example of setting the operating capability of the apparatus in accordance with the type of the touch operation, an operating speed of the touch operation and the load ratio of the apparatus.

Thus, the information processing apparatus 10 according to the embodiment can determine the type of the touch operation on the basis of the time-course variation of state quantity such as the moving distance TR and the moving speed TV related to the touch operation accompanying the execution of the application. Then, the information processing apparatus 10 according to the embodiment can select and set the governor table per determined type of the touch operation. Consequently, the information processing apparatus 10 according to the embodiment can determine the type of the touch operation about an additionally obtained application, and can select and set the governor table suited to the determined type of the touch operation.

The information processing apparatus 10 according to the embodiment can select the governor table suited to the determined type of the touch operation, can switch over the selected governor table to the standard governor table of the power emphasized type or the performance emphasized type, and can set this governor table as the table used for implementing the governor control accompanying the execution of the application. The information processing apparatus 10 according to the embodiment can perform setting the drive voltage, the operation frequency and the operation core count in a way that corresponds to the processing load on the basis of the selected governor table. Therefore, the information processing apparatus 10 according to the embodiment can restrain the power consumption and ensure the performance each suited to the type of the touch operation accompanying the execution of the application. In the information processing apparatus 10 according to the embodiment, it is feasible to provide a power consumption restraining technology suited to the application executed on the information processing apparatus 10.

(Example of Governor Control)

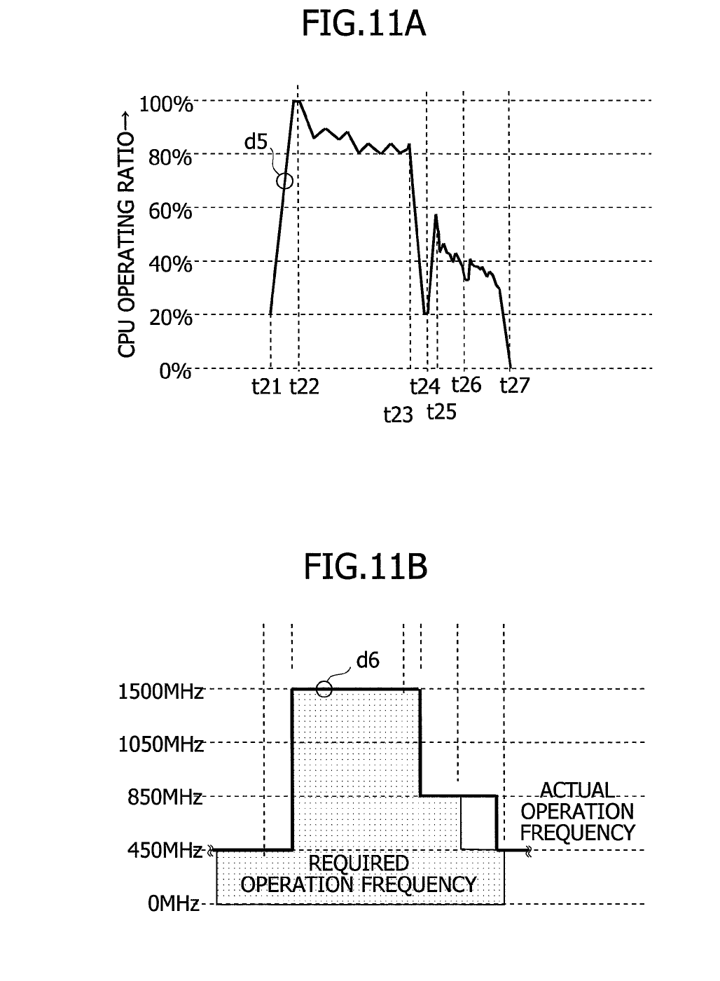

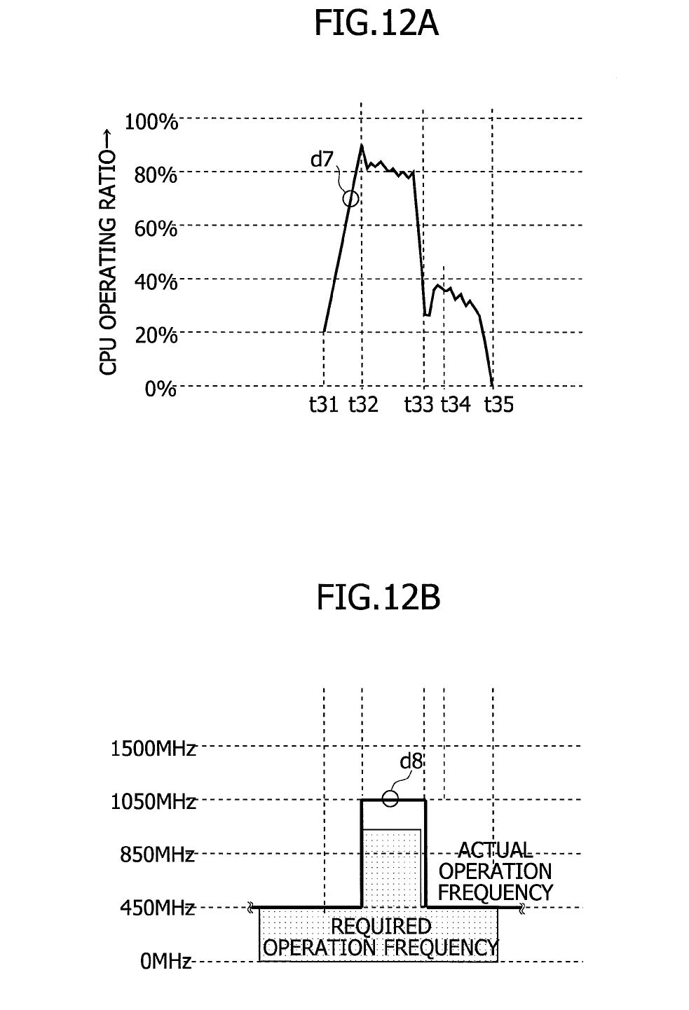

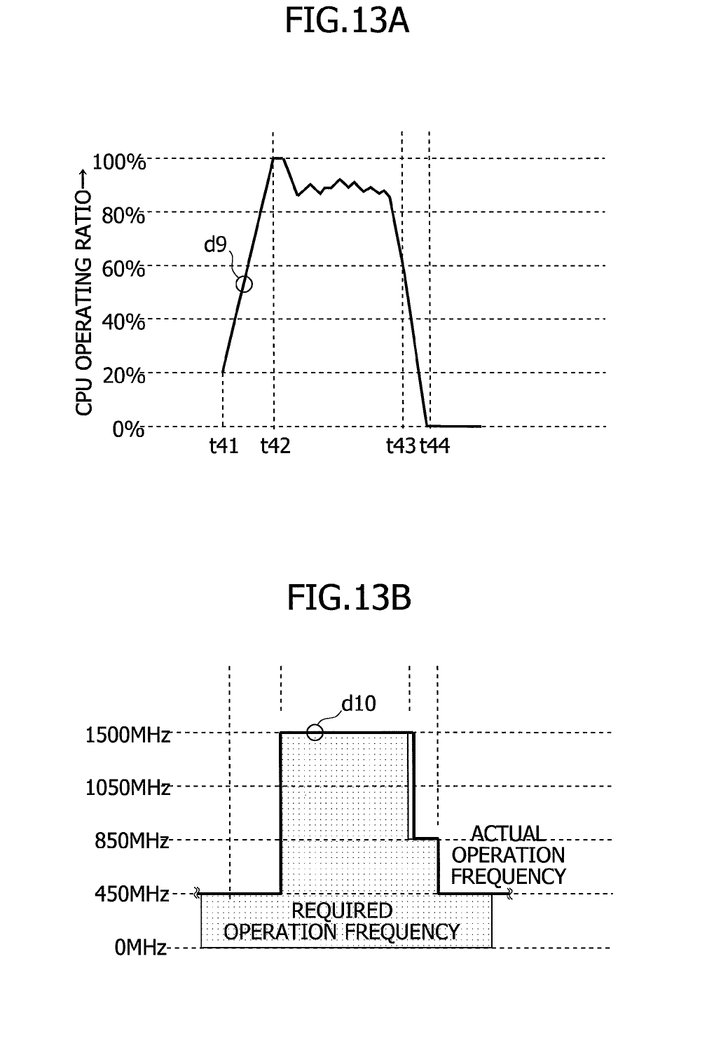

FIGS. 11 through 13 illustrate examples of transition of the operation frequency, which use the governor tables in the embodiments. FIG. 11 illustrates the example of the governor control about the flick operation categorized as the type of the touch operation, in which the governor table specified by, e.g., “when normal in flick” in FIG. 8A2 is applied. Similarly, FIG. 12 illustrates the example of the governor control about the tap operation, in which the governor table specified by, e.g., “when slow in tap” in FIG. 8B3 is applied. Further, FIG. 13 illustrates the example of the governor control about the swipe operation, in which the governor table specified by, e.g., “when normal in swipe” in FIG. 8C3 is applied.

(Applied Example of Flick Operation)

FIG. 11A illustrates an example of the transition (graph d5) of the CPU operating ratio accompanying the flick operation. The axis of ordinates in FIG. 11A indicates the CPU operating ratio representing the processing load of the processor of the information processing apparatus 10, while the axis of abscissas indicates the time. Further, FIG. 11B illustrates an example of the transition (graph d6) of the operation frequency with respect to the processing load in FIG. 11A. The axis of ordinates in FIG. 11B indicates the clock frequency representing the operation frequency of the information processing apparatus, while the axis of abscissas indicates the time. Moreover, in FIG. 11B, an area indicated by hatching exemplifies the operation frequency enabling the performance to be ensured with respect to the processing load.

In FIG. 11A, the processing load of the processor of the information processing apparatus 10 when performing the flick operation transitions such as (t21, 20%)→(t22, 100%)→(t23, 82%)→(t24, 20%)→(t25, 58%)→(t26, 30%)→(t27, 0%). It is to be noted that “txx (x=21 to 27) is normalized time, and “XXX % (XXX=0 to 100)” is the CPU operating ratio.

In FIG. 11A, the CPU operating ratio from the timing t21 to the timing t22 steeply increases up to 100% from 20%. With this variation of the CPU operating ratio, the information processing apparatus 10 gets the operation frequency to transition on the basis of the example of the governor table specified by, e.g., “when normal in flick” in FIG. 8A2. In the example of the governor table specified by “when normal in flick” in FIG. 8A2, the range of CPU operating ratios for transitioning to the 4-stage operation frequencies is stored in the row associated with the “450” column in the vertical line of the “present/next” column.

The CPU operating ratio at the timing t22 in FIG. 11A is 100% and is included in the range of CPU operating ratio of “100-80”% associated with “1500” MHz as the post-transition operation frequency in FIG. 8A2. Therefore, the information processing apparatus 10 can get the operation frequency during the operation to transition to “1500” MHz with respect to the variation of the CPU operating ratio from the timing t21 to the timing t22 in FIG. 11A. In the information processing apparatus 10 undergoing the setting of the example of the governor table of FIG. 8A2, for instance, even when a steep variation of the processing load from the timing t21 to the timing t22 in FIG. 11A occurs with the flick operation, it is possible to set the operation frequency suited to the variation of the processing load. The information processing apparatus 10 can ensure the performance that follows the steep variation of the processing load with the flick operation. Furthermore, for instance, it is feasible to minimize, as illustrated in FIG. 1B etc., the frequency difference occurring between the operation frequency transitioning corresponding to the variation of the processing load and the operation frequency for ensuring the performance.

Moreover, in FIG. 11A, the CPU operating ratio from the timing t23 to the timing t24 decreases steeply from 82% down to 20%. With respect to this variation of the CPU operating ratio, the information processing apparatus 10 being operated at the operation frequency of “1500” Mhz similarly gets the operation frequency to transition on the basis of the example of the governor table specified by “when normal in flick” in FIG. 8A2. The CPU operating ratio at the timing t24 in FIG. 11A is 20% and is included in the range of CPU operating ratio of “24-0”% associated with “850” MHz as the post-transition operation frequency in FIG. 8A2. The information processing apparatus 10 gets the operation frequency of “1500” Mhz during the operation to transition to “850” MHz with respect to the variation of the CPU operating ratio from the timing t21 to the timing t22 in FIG. 11A.

The flick operation involves continuing the scroll consecutively even after the operation finger 90 has released as illustrated in, e.g., FIG. 3C. Therefore, in the information processing apparatus 10, it follows that the CPU operating ratio temporarily decreases down to 20% and again rises up to approximately 60% as seen at, e.g., the timing t25 in FIG. 11A. In the information processing apparatus 10 undergoing the setting of the example of the governor table in FIG. 8A2, even when the CPU operating ratio decreases down to 20%, the operation frequency working underway at “1500” Mhz can stop decreasing down to “850” MHz. Hence, the information processing apparatus 10 can keep the performance for the scroll continued after the release.

### (Applied Example of Tap Operation)

FIG. 12A illustrates an example of the transition (graph d7) of the CPU operating ratio accompanying the tap operation. The axis of ordinates in FIG. 12A indicates the CPU operating ratio representing the processing load of the processor of the information processing apparatus 10, while the axis of abscissas indicates the time. Further, FIG. 12B illustrates an example of the transition (graph d8) of the operation frequency with respect to the processing load in FIG. 12A. The axis of ordinates in FIG. 12B indicates the clock frequency representing the operation frequency of the information processing apparatus, while the axis of abscissas indicates the time. Moreover, in FIG. 12B, an area indicated by hatching exemplifies the operation frequency enabling the performance to be ensured with respect to the processing load.

In FIG. 12A, the processing load of the processor of the information processing apparatus 10 when performing the tap operation transitions such as (t31, 20%)→(t32, 84%)→(t33, 28%)→(t34, 36%)→(t35, 0%). It is to be noted that “txx (x=321 to 35) is normalized time, and “XXX % (XXX=0 to 100)” is the CPU operating ratio.

In FIG. 12A, the CPU operating ratio from the timing t31 to the timing t32 steeply increases up to 86% from 20%. With this variation of the CPU operating ratio, the information processing apparatus 10 gets the operation frequency to transition on the basis of the example of the governor table specified by, e.g., “when slow in tap” in FIG. 8B3. In the example of the governor table specified by “when slow in tap” in FIG. 8B3, the range of CPU operating ratios for transitioning to the 3-stage operation frequencies is stored in the row associated with the “450” column in the vertical line of the “present/next” column.

In the example of the governor table specified by “when slow in tap” in FIG. 8B3, there is not setting of the CPU operating ratio associated with the operation frequency of “1500” MHz being transition-enabled corresponding to the variation of the processing load from “450” MHz during the operation. Consequently, in the information processing apparatus 10 undergoing the setting of the example of the governor table in FIG. 8B3, e.g., even in the case of the occurrence of the steep variation of the processing load from the timing t31 to the timing t32 in FIG. 12A with the tap operation, the operation does not shift to the operating state at the excessively high clock frequency.

The CPU operating ratio at the timing t32 in FIG. 12A is 86% and is included in the range of CPU operating ratio of “100-80”% associated with “1050” MHz as the post-transition operation frequency in FIG. 8B3. The information processing apparatus 10 can get the operation frequency during the operation to stop increasing up to “1050” MHz with respect to the variation of the CPU operating ratio from the timing t31 to the timing t32 in FIG. 12A. Therefore, for instance, as illustrated in FIG. 2B etc., it does not happen that the operation frequency transitioning corresponding to the variation of the processing load becomes the excessively high clock frequency for the operation frequency for ensuring the performance. In the information processing apparatus 10 undergoing the setting of the example of the governor table of FIG. 8B3, it is feasible to minimize the frequency difference occurring between the operation frequency transitioning corresponding to the variation of the processing load and the operation frequency for ensuring the performance with respect to the tap operation. In the information processing apparatus 10 undergoing the setting of the example of the governor table of FIG. 8B3, it is possible to improve the effect in restraining the power consumption for the tap operation accompanying the execution of the application.

Moreover, in the information processing apparatus 10 being operated underway at the operation frequency of “1050” MHz in FIG. 12A, the CPU operating ratio at the timing t34 decreases down to about 36% under 40%. In the example of the governor table specified by “when slow in tap” in FIG. 8B3, the CPU operating ratio at the timing t34 is included in the range of CPU operating ratio of “39-0”% associated with “450” MHz as the post-transition operation frequency. The information processing apparatus 10 gets the operation frequency of “1050” Mhz during the operation to transition to “450” MHz with respect to the variation of the CPU operating ratio at the timing t34 in FIG. 12A. Hence, in the information processing apparatus 10 undergoing the setting of the example of the governor table in FIG. 8B3, for instance, as illustrated in FIG. 2B etc., it does not happen that the operation frequency of the information processing apparatus 10 continues being kept over a predetermined period in the state of the high clock frequency. The information processing apparatus 10 can set the operation frequency suited to the performance by following the variation of the processing load accompanying the tap operation. Therefore, the information processing apparatus 10 can minimize the frequency difference occurring between the operation frequency transitioning corresponding to the variation of the processing load and the operation frequency for ensuring the performance even in the transition from the high clock frequency to the low clock frequency.

(Applied Example of Swipe Operation)

FIG. 13A illustrates an example of the transition (graph d9) of the CPU operating ratio accompanying the swipe operation. The axis of ordinates in FIG. 13A indicates the CPU operating ratio representing the processing load of the processor of the information processing apparatus 10, while the axis of abscissas indicates the time. Further, FIG. 13B illustrates an example of the transition (graph d10) of the operation frequency with respect to the processing load in FIG. 13A. The axis of ordinates in FIG. 13B indicates the clock frequency representing the operation frequency of the information processing apparatus, while the axis of abscissas indicates the time. Moreover, in FIG. 13B, an area indicated by hatching exemplifies the operation frequency enabling the performance to be ensured with respect to the processing load.

In FIG. 13A, the processing load of the processor of the information processing apparatus 10 when performing the swipe operation transitions such as (t41, 20%)→(t42, 100%)→(t43, 58%)→(t44, 0%). It is to be noted that “txx (x=41 to 44) is normalized time, and “XXX % (XXX=0 to 100)” is the CPU operating ratio.

In FIG. 13A, the CPU operating ratio from the timing t41 to the timing t42 steeply increases up to 100% from 20%. With this variation of the CPU operating ratio, the information processing apparatus 10 gets the operation frequency to transition on the basis of the example of the governor table specified by, e.g., “when slow in swipe” in FIG. 8C3. In the example of the governor table specified by “when slow in swipe” in FIG. 8C3, the range of CPU operating ratios for transitioning to the 4-stage operation frequencies is stored in the row associated with the “450” column in the vertical line of the “present/next” column.

The CPU operating ratio at the timing t42 in FIG. 13A is 100% and is included in the range of CPU operating ratio of “100-80”% associated with “1500” MHz as the post-transition operation frequency in FIG. 8C3. Hence, the information processing apparatus 10 being operated at the operation frequency of “450” NHz can get the operation frequency during the operation to transition to the state of “1500” MHz with respect to the steep variation of the CPU operating ratio from the timing t41 to the timing t42 in FIG. 13A. In the information processing apparatus 10 undergoing the setting of the example of the governor table in FIG. 8C3, there is set the operation frequency suited to the variation of the processing load as well as suited to the steep variation of the processing load from the timing t41 to the timing t42 in FIG. 13A, the variation accompanying, e.g., the swipe operation. As depicted in FIG. 13B, it is possible to minimize the frequency difference occurring between the operation frequency for ensuring the performance and the operation frequency transitioning corresponding to the variation of the processing load. The information processing apparatus 10 minimizes the frequency difference occurring between the operation frequency for ensuring the performance and the operation frequency transitioning corresponding to the variation of the processing load, and can therefore improve the effect in restraining the power consumption. The information processing apparatus 10 can ensure the performance following the steep variation of the processing load accompanying the swipe operation and can enhance the effect in restraining the power consumption.

Moreover, in the information processing apparatus 10 being operated underway at the operation frequency of “1050” MHz in FIG. 13A, the CPU operating ratio at the timing t43 decreases down to about 58% under 60%. Then, with the stop of the movement in the swipe operation, the CPU operating ratio at the timing t44 in FIG. 13A decreases down to 0%.

In the example of the governor table specified by “when slow in swipe” in FIG. 8C3, the CPU operating ratio at the timing t43 is included in the range of CPU operating ratio of “59-30”% associated with “850” MHz as the post-transition operation frequency. The information processing apparatus 10 gets the operation frequency of “1500” Mhz during the operation to transition to “850” MHz with respect to the variation of the CPU operating ratio at the timing t43 in FIG. 13A. In the example of the governor table in FIG. 8C3, the CPU operating ratio associated with “850” MHz at the timing t44 is included in the range of CPU operating ratio of “49-0”% associated with “450” MHz as the post-transition operation frequency. Hence, the information processing apparatus 10 temporarily shifts to “850” MHz for the variation of the processing load which leads to the stop of the movement in the swipe operation, and thereafter shifts to the lowest operation frequency of “450” MHz. Consequently, the information processing apparatus 10 can, as illustrated in FIG. 13B, minimize the frequency difference between the operation for ensuring the performance and the frequency transitioning corresponding to the variation of the processing load in the transition also from the high clock frequency to the low clock frequency.

According to the information processing apparatus described above, it is feasible to restrain the power consumption in the state suited to the application executed on the information processing apparatus.

<<Non-Transitory Computer Readable Recording Medium>>

A program for making a computer, other machines and apparatuses (which will hereinafter be referred to as the computer etc) realize any one of the functions can be recorded on a non-transitory recording medium readable by the computer etc. Then, the computer etc is made to read and execute the program on this non-transitory recording medium, whereby the function thereof can be provided.

Herein, the non-transitory recording medium readable by the computer etc connotes a non-transitory recording medium capable of accumulating information such as data and programs electrically, magnetically, optically, mechanically or by chemical action, which can be read from the computer etc. Among these non-transitory recording mediums, for example, a flexible disc, a magneto-optic disc, a CD-ROM, a CD-R/W, a DVD, a Blu-ray disc, a DAT, an 8 mm tape, a memory card such as a flash memory are given as those removable from the computer etc. Further, a hard disc, a ROM (Read-Only Memory), etc are given as the non-transitory recording mediums fixed within the computer etc.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising a processor executing a process that causes the information processing apparatus to:
perform first acquiring a type and an operation speed of a touch operation on an instruction field on a detection surface;
perform second acquiring a load ratio of the apparatus; and
perform setting an operating capability of the apparatus in accordance with the type of the touch operation and the load ratio of the apparatus.

2. The information processing apparatus according to claim 1, wherein the setting includes setting the operating capability of the apparatus in accordance with the type and the operation speed of the touch operation and the load ratio of the apparatus.

3. The information processing apparatus according to claim 1, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the flick operation, the operation frequency of the apparatus being operated underway to transition a highest operation frequency in the way of being associated with a steep increase in load ratio, and getting the operation frequency to transition not to decrease under a first predetermined operation frequency with respect to a reduction in load ratio.

4. The information processing apparatus according to claim 1, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the swipe operation and when the operation speed is lower than a predetermined threshold value, the operation frequency during the operation to transition so that the operation frequency of the apparatus does not increase over a second predetermined operation frequency even when the load ratio steeply rises.

5. The information processing apparatus according to claim 1, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the tap operation and when a tap-to-tap interval is longer than a predetermined threshold value, the operation frequency during the operation to transition so that the operation frequency of the apparatus does not increase over the second predetermined operation frequency even when the load ratio steeply rises, and getting, when the tap-to-tap interval is shorter than the predetermined threshold value, the operation frequency during the operation to transition so that the operation frequency of the apparatus does not decrease under the first predetermined operation frequency with respect to a reduction in load ratio.

6. A non-transitory computer-readable recording medium having stored therein a control program of an information processing apparatus including a processor, the control program to cause the processor to perform:
first acquiring a type and an operation speed of a touch operation on an instruction field on a detection surface;
second acquiring a load ratio of the apparatus; and
setting an operating capability of the apparatus in accordance with the type of the touch operation and the load ratio of the apparatus.

7. The non-transitory computer-readable recording medium having stored therein a control program according to claim 6, wherein the setting includes setting the operating capability of the apparatus in accordance with the type and the operation speed of the touch operation and the load ratio of the apparatus.

8. The non-transitory computer-readable recording medium having stored therein a control program according to claim 6, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the flick operation, the operation frequency of the apparatus being operated underway to transition a highest operation frequency in the way of being associated with a steep increase in load ratio, and getting the operation frequency to transition not to decrease under a first predetermined operation frequency with respect to a reduction in load ratio.

9. The non-transitory computer-readable recording medium having stored therein a control program according to claim 6, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the swipe operation and when the operation speed is lower than a predetermined threshold value, the operation frequency during the operation to transition so that the operation frequency of the apparatus does not increase over a second predetermined operation frequency even when the load ratio steeply rises.

10. The non-transitory computer-readable recording medium having stored therein a control program according to claim 6, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the tap operation and when a tap-to-tap interval is longer than a predetermined threshold value, the operation frequency during the operation to transition so that the operation frequency of the apparatus does not increase over the second predetermined operation frequency even when the load ratio steeply rises, and getting, when the tap-to-tap interval is shorter than the predetermined threshold value, the operation frequency during the operation to transition so that the operation frequency of the apparatus does not decrease under the first predetermined operation frequency with respect to a reduction in load ratio.

11. A control method comprising:
first acquiring a type and an operation speed of a touch operation on an instruction field on a detection surface;
second acquiring a load ratio of the apparatus; and
setting an operating capability of the apparatus in accordance with the type of the touch operation and the load ratio of the apparatus.

12. The control method according to claim 11, wherein the setting includes setting the operating capability of the apparatus in accordance with the type and the operation speed of the touch operation and the load ratio of the apparatus.

13. The control method according to claim 11, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the flick operation, the operation frequency of the apparatus being operated underway to transition a highest operation frequency in the way of being associated with a steep increase in load ratio, and getting the operation frequency to transition not to decrease under a first predetermined operation frequency with respect to a reduction in load ratio.

14. The control method according to claim 11, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the swipe operation and when the operation speed is lower than a predetermined threshold value, the operation frequency during the operation to transition so that the operation frequency of the apparatus does not increase over a second predetermined operation frequency even when the load ratio steeply rises.

15. The control method according to claim 11, wherein any one of a flick operation, a swipe operation and a tap operation is determined as the type of the touch operation on the basis of a range of a touch position on the instruction field on the detection surface and a high/low level of the operation speed, and
the setting includes setting the operation capability of getting, when determining that the touch operation is the tap operation and when a tap-to-tap interval is longer than a predetermined threshold value, the operation frequency during the operation to transition so that the operation frequency of the apparatus does not increase over the second predetermined operation frequency even when the load ratio steeply rises, and getting, when the tap-to-tap interval is shorter than the predetermined threshold value, the operation frequency during the operation to transition so that the operation frequency of the apparatus does not decrease under the first predetermined operation frequency with respect to a reduction in load ratio.
